(19) United States
(12) Patent Application Publication
(10) Pub. No.: US 2026/0258924 A1
(43) Pub. Date: Sep. 3, 2026

(54) VEHICULAR LAMP AND VEHICLE

(71) Applicant: Nichia Corporation, Anan-shi, Tokushima (JP)

(72) Inventors: Masaru KATO, Sagamihara-shi (JP); Hiroshi MIYAIRI, Yokohama-shi (JP); Yusuke KAWANO, Anan-shi (JP)

(73) Assignee: Nichia Corporation, Anan-shi, Tokushima (JP)

(21) Appl. No.: 19/159,574

(22) PCT Filed: Feb. 26, 2024
(86) PCT No.: PCT/JP2024/006727

§ 371 Date: Aug. 25, 2025

(30) Foreign Application Priority Data
Feb. 27, 2023 (JP) 2023-028754
Apr. 3, 2023 (JP) 2023-060390

(51) Int. Cl. F21S 41/25

(52) U.S. Cl. CPC F21S 41/25

(57) ABSTRACT

A vehicular lamp having excellent variety of light distributions is provided. The vehicular lamp includes a plurality of light emitting devices including a first light emitting device and a second light emitting device and being individually drivable; and a plurality of optical systems including a first optical system and a second optical system. The first optical system is configured to output light having a first light distribution based on light incident thereon from the first light emitting device. The second optical system is configured to output light having a second light distribution based on light incident thereon from the second light emitting device. A light emitting area of the first light emitting device is different from a light emitting area of the second light emitting device. A light distribution angle of the first light distribution is different from a light distribution angle of the second light distribution.

### TECHNICAL FIELD

The present disclosure relates to a vehicular lamp and a vehicle.

### BACKGROUND ART

Conventionally, vehicular lamps including light emitting devices, such as Light Emitting Diodes (LEDs) and the like, have been widely used. As such a vehicular lamp, one that has a light guide between a light emitting device and a projection lens has been disclosed.

### CITATION LIST

### Patent Literature

PTL 1: Japanese Patent Application Laid-Open Publication No. 2022-94635

### SUMMARY OF THE INVENTION

### Technical Problem

However, in the vehicular lamp described in PTL 1, the variety of light distributions obtained by the vehicular lamp might be limited because a single projection lens is used for a plurality of light emitting elements.

An object of an embodiment of the present disclosure is to provide a vehicular lamp having a good variety of light distributions.

### Solution To The Problem

A vehicular lamp according to an embodiment of the present disclosure includes: a plurality of light emitting devices including a first light emitting device and a second light emitting device and being individually drivable; and a plurality of optical systems including a first optical system and a second optical system. The first optical system is configured to output light having a first light distribution based on light incident thereon from the first light emitting device. The second optical system is configured to output light having a second light distribution based on light incident thereon from the second light emitting device. A light emitting area of the first light emitting device is different from a light emitting area of the second light emitting device. A light distribution angle of the first light distribution is different from a light distribution angle of the second light distribution.

### Advantageous Effects of the Invention

According to an embodiment of the present disclosure, it is possible to provide a vehicular lamp having a good variety of light distributions.

### BRIEF DESCRIPTION OF THE DRAWINGS

FIG. 1 is an oblique view showing an example of a vehicular lamp according to a first embodiment.

FIG. 2 is an oblique view showing an example of light emitting devices and optical systems according to the first embodiment.

FIG. 3 is a side view showing an example of the light emitting devices and the optical systems according to the first embodiment.

FIG. 4 is a schematic top view showing an example of a first light emitting device of a plurality of light emitting devices.

FIG. 5 is a schematic top view showing an example of a second light emitting device of a plurality of light emitting devices.

FIG. 6 is a schematic top view showing an example of a third light emitting device of a plurality of light emitting devices.

FIG. 7 is a schematic cross-sectional view of FIG. 4 along a line VII-VII.

FIG. 8 is a schematic cross-sectional view of FIG. 3 along a line VIII-VIII.

FIG. 9 is a bottom view showing an example of TIR lenses according to the first embodiment.

FIG. 10 is a top view showing an example of the TIR lenses according to the first embodiment.

FIG. 11 is a view explaining a first virtual light source image according to the first embodiment.

FIG. 12 is a view explaining a second virtual light source image according to the first embodiment.

FIG. 13 is a view showing an example of light distributions according to the first embodiment.

FIG. 14 is a first drawing showing the relationship between the light emitting area and the light distribution luminosity in a wide-angle light distribution.

FIG. 15 is a second drawing showing the relationship between the light emitting area and the light distribution luminosity in a wide-angle light distribution.

FIG. 16 is a graph showing an example of the relationship between the light emitting area and the light distribution luminosity in a narrow-angle light distribution.

FIG. 17 is a schematic diagram showing a modification example of the arrangement of the light emitting devices and the optical systems.

FIG. 18 is a schematic diagram showing an example of a vehicle according to a second embodiment.

FIG. 19 is a block diagram showing the hardware configuration of a control unit according to the second embodiment.

FIG. 20 is a block diagram showing the functional configuration of the control unit according to the second embodiment.

FIG. 21 is a diagram showing an example of a correspondence table according to the second embodiment.

FIG. 22 is a diagram showing an example of road surface illuminance during traveling.

FIG. 23 is a diagram showing an example of road surface illuminance during traveling in an urban suburb.

FIG. 24 is a diagram showing an example of road surface illuminance during traveling on an expressway.

FIG. 25 is a diagram showing an example of road surface illuminance during traveling in bad weather.

FIG. 26 is a diagram showing an example of light distribution during driving.

FIG. 27 is a diagram showing an example of a light distribution during traveling in a suburb.

FIG. 28 is a diagram showing an example of a light distribution during traveling on an expressway.

FIG. 29 is a diagram showing an example of a light distribution during traveling in bad weather.

FIG. 30A is a schematic top view showing an example of the first light emitting device of a modification example 1.

FIG. 30B is a cross-sectional view of the first light emitting device of the modification example 1 along a line XXXB-XXXB.

FIG. 30C is a cross-sectional view of the first light emitting device of the modification example 1 along a line XXXC-XXXC.

FIG. 31 is a schematic top view showing an example of the first light emitting device of a modification example 2.

FIG. 32A is a schematic top view showing an example of the first light emitting device of a modification example 3.

FIG. 32B is a cross-sectional view of the first light emitting device of the modification example 3 along a line XXXIIB-XXXIIB.

### DETAILED DESCRIPTION OF THE INVENTION

A vehicular lamp and a vehicle according to an embodiment of the present disclosure will be described in detail with reference to the drawings. However, the following embodiment is an example of a vehicular lamp and a vehicle for embodying the technical idea of the present disclosure, and is not intended as limitation thereto. The dimensions, materials, shapes, relative positioning, and the like of the components described in the following embodiment are not intended to limit the scope of the present disclosure only to them, but are merely illustrative examples unless otherwise specified. The size, positional relationship, and the like of the members shown in the drawings may be exaggerated in order to clarify the explanation. Also, in the following description, the same names and reference numerals represent the same or homogeneous members, and the detailed description of such members will be omitted where appropriate. As a cross-sectional view, an end view showing only a cut surface may be used.

In each drawing, an orthogonal coordinate system with X, Y and Z axes is used as the direction indication. The X, Y and Z axes are substantially orthogonal to each other. The X direction along the X axis and the Y direction along the Y axis indicate directions along the light emitting surfaces of the light emitting devices included in the vehicular lamp according to an embodiment. The Z direction along the Z axis indicates the direction orthogonal to the light emitting surfaces. That is, the light emitting surfaces of the light emitting devices are parallel with the XY plane, and the Z axis is orthogonal to the XY plane.

The direction that the arrow points in the X direction is denoted as the +X direction or the +X side, and the direction opposite to the +X direction is denoted as the −X direction or the −X side. The direction that the arrow points in the Y direction is denoted as the +Y direction or the +Y side, and the direction opposite to the +Y direction is denoted as the −Y direction or the −Y side. The direction that the arrow points in the Z direction is denoted as the upward direction, the +Z direction, or the +Z side, and the direction opposite to the +Z direction is denoted as the −Z direction or the −Z side. As one example, the light emitting devices included in the vehicular lamp according to the embodiments emit light to the +Z side. The light axis of the lenses of the optical systems according to the embodiment is along the Z axis.

A term “top view” as used in the embodiment means a view of an object in the +Z direction. A term “bottom view” as used in the embodiment means a view of an object in the −Z direction. In the embodiment, a surface of an object viewed in the +Z direction or from the +Z side is referred to as “upper surface”, and a surface of an object viewed in the −Z direction or from the −Z side is referred to as “lower surface”. However, these are not intended to limit the orientations of the vehicular lamp and the vehicle during use, and the orientations of the vehicular lamp and the vehicle may be appropriately selected. In the embodiment described below, “objects being along the X, Y and Z axes” encompasses a case in which the objects are inclined within ±10° from these axes. In the embodiment, “orthogonal” may include a deviation within ±10° from 90°.

When there are a plurality of components in the specification or in the claims and they are denoted separately from each other, these components may be distinguished by adding “first”, “second”, and the like before the components. Moreover, distinction of the objects in the specification may be different from those in the claims. Therefore, even if any components with the same affixes as used in the specification are recited in the claims, there may be a case in which the objects identified by such components in the specification are not the Same as those in the claims.

### [First Embodiment]

### <Example of Overall Configuration of Vehicular Lamp 100>

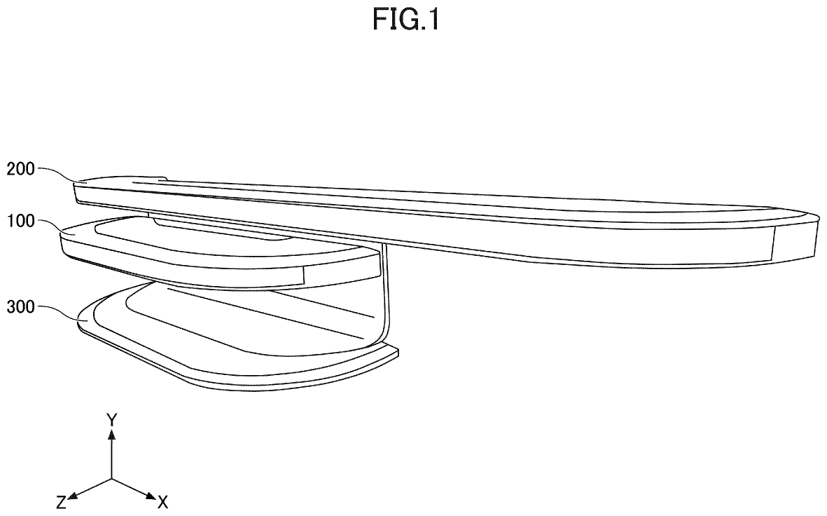

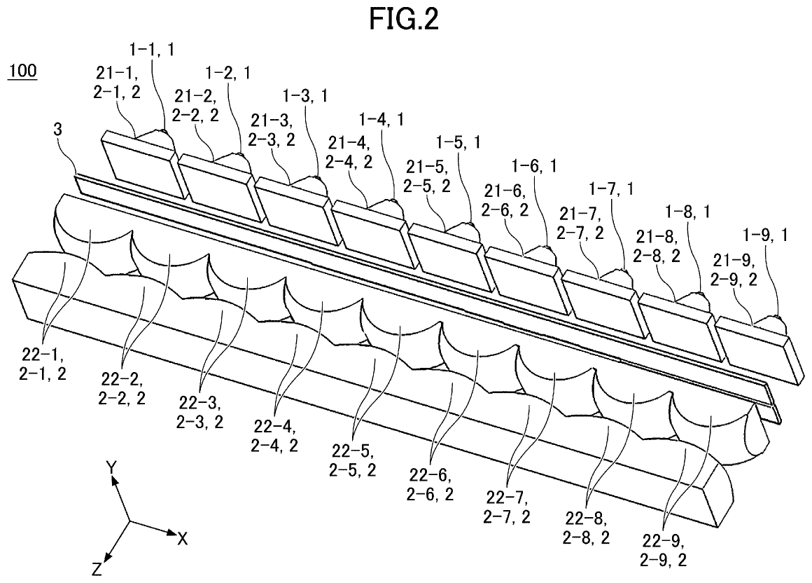

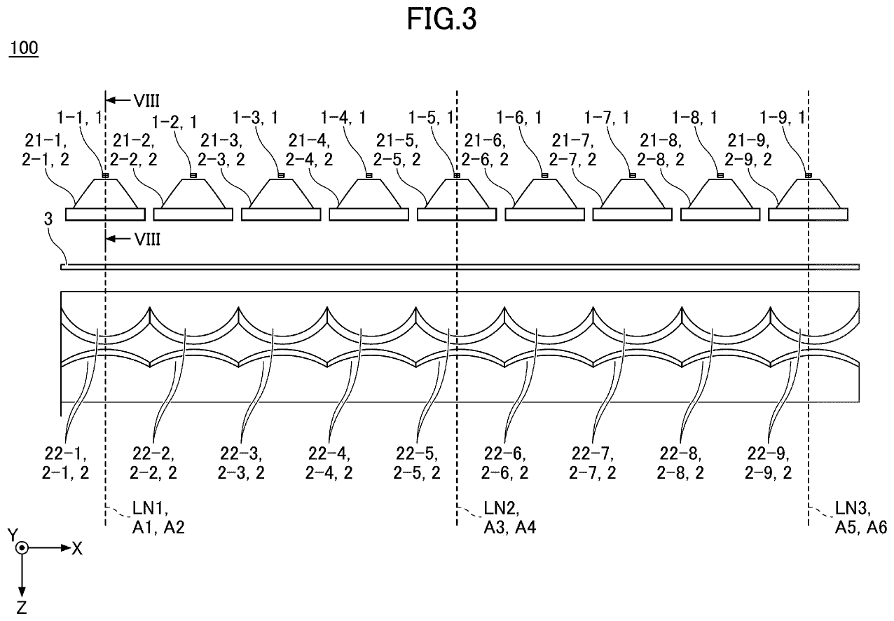

With reference to FIGS. 1 to 3, the overall configuration of a vehicular lamp according to a first embodiment will be described. FIG. 1 is an oblique view showing an example of a vehicular lamp 100 according to the first embodiment. FIGS. 2 and 3 are diagrams showing an example of a plurality of light emitting devices 1 and a plurality of optical systems 2 included in the vehicular lamp 100. FIG. 2 is an oblique view from the +Y side, and FIG. 3 is a side view from the +Y side. FIGS. 2 and 3 show the plurality of light emitting devices 1, the plurality of optical systems 2, and the like arranged in the housing of the vehicular lamp 100 of FIG. 1 in a state in which the housing is removed.

In FIG. 1, the vehicular lamp 100 is a lighting fixture mounted on a vehicle and configured to illuminate the surroundings of the vehicle. The vehicle encompasses an automobile, a train, a locomotive, a freight train, an automatic guided vehicle, and the like. The vehicular lamp 100 shown in FIG. 1 is, for example, a headlight of an automobile. The vehicular lamp 100 is mounted on an automobile and emits light for a light distribution of a low beam, which is a passing headlight. In FIG. 1, a high-beam lighting fixture 200 emits light for a light distribution of a high beam, which is a driving headlight. A support member 300 supports the vehicular lamp 100 and the high-beam lighting fixture 200. The high-beam lighting fixture 200 may be, for example, one that includes the elements of the vehicular lamp 100 described below other than a shade member 3. The high-beam lighting fixture 200 may be, for example, the vehicular lamp 100 described below from which a first lens, a third lens, and a fifth lens are omitted.

As shown in FIGS. 2 and 3, in this embodiment, the vehicular lamp 100 includes the plurality of light emitting devices 1, the plurality of optical systems 2, and the shade member 3. In the example shown in FIGS. 2 and 3, the plurality of light emitting devices 1 includes light emitting devices 1-1 to 1-9. The plurality of light emitting devices 1 are mounted on a substrate. The plurality of light emitting devices 1 can be driven individually. The light emitting devices 1-1 to 1-9 are arranged in a row in the X direction. In other words, the plurality of light emitting devices 1 are arranged in a one-dimensional grid form in the X direction. The plurality of optical systems 2 include optical systems 2-1 to 2-9. The plurality of optical systems 2 are in one-to-one correspondence to the plurality of light emitting devices 1, and are arranged in a row in the X direction. £ In other words, the plurality of optical systems 2 are arranged in a one-dimensional grid form in the X direction. The number of the plurality of light emitting devices 1 is not limited to nine and may be any number. The number of the plurality of optical systems 2 is not limited to nine and may be any number in accordance with the number of the plurality of light emitting devices 1.

Among the plurality of light emitting devices 1, the light emitting device 1-1 is an example of a first light emitting device. The light emitting device 1-5 is an example of a second light emitting device. The light emitting device 1-9 is an example of a third light emitting device.

Among the plurality of optical systems 2, the optical system 2-1 is an example of a first optical system. In this embodiment, based on the light that is incident from the light emitting device 1-1, light having a first light distribution is emitted from the optical system 2-1. The optical system 2-1 includes a Total Internal Reflection (TIR) lens 21-1 and a projection lens 22-1. The TIR lens 21-1 is an example of a first lens. The projection lens 22-1 is an example of a second lens.

Among the plurality of optical systems 2, the optical system 2-5 is an example of a second optical system. In this embodiment, based on light that is incident from the light emitting device 1-5, light having a second light distribution is emitted from the optical system 2-5. The optical system 2-5 includes a TIR lens 21-5 and a projection lens 22-5. The TIR lens 21-5 is an example of a third lens. The projection lens 22-5 is an example of a fourth lens.

Among the plurality of optical systems 2, the optical system 2-9 is an example of a third optical system. In this embodiment, based on light that is incident from the light emitting device 1-9, light having a third light distribution is emitted from the optical system 2-9. The optical system 2-9 includes a TIR lens 21-9 and a projection lens 22-9. The TIR lens 21-9 is an example of a fifth lens. The projection lens 22-9 is an example of a sixth lens.

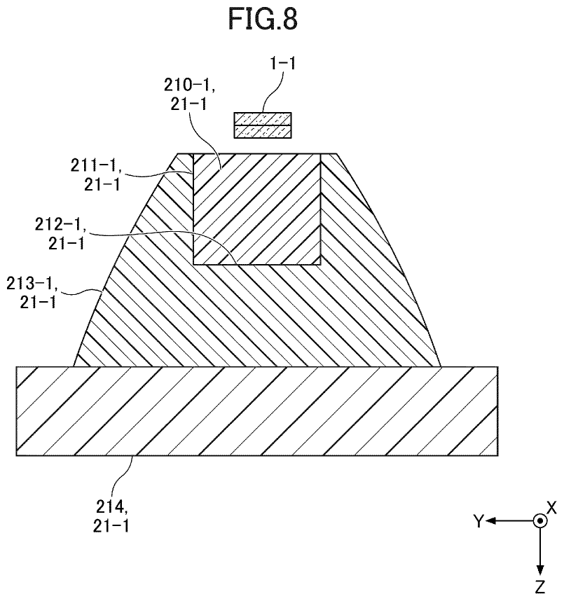

The TIR lenses 21-1 to 21-9 are lenses having a reflecting part. In the plurality of optical systems 2 according to this embodiment, inclusion of the TIR lenses 21-1 to 21-9 allows for increasing the light utilization efficiency of the optical systems 2. However, the plurality of optical systems 2 is not limited to the ones including the TIR lenses 21-1 to 21-9, and may include a plurality of refractive lenses, a plurality of diffractive lenses, or the like. The details of the TIR lenses 21-1 to 21-9 will be described separately with reference to FIGS. 8 to 10.

The projection lenses 22-1 to 22-9 include two lens arrays each including nine plano-convex lenses that are arranged in the X direction. Among the nine plano-convex lenses included in each lens array, adjacent plano-convex lenses are joined together. The two lens arrays are arranged such that the convex surfaces of the plano-convex lenses face each other and form the respective projection lenses 22-1 to 22-9. However, the projection lenses 22-1 to 22-9 are not limited to combination of two lens arrays each including nine plano-convex lenses. Respective ones of the projection lenses 22-1 to 22-9 may include a plano-concave lens array, a biconvex lens array, a meniscus lens array, and the like, may include one, or three or more lens arrays, and may include a diffractive lens array, a Fresnel lens array, and the like. The number of lenses included in a single lens array is not limited to nine, but may be a number corresponding to the number of light emitting devices 1. The nine lenses included in a lens array do not need to be joined together. As long as light having the first light distribution, light having the second light distribution, and light having the third light distribution are respectively emitted from the first optical system, the second optical system, and the third optical system, the shapes of the projection lenses 22-1 to 22-9 may be the same as each other, or at least one or more of them may have different shapes.

Each of the optical systems 2 is not limited to the one including the TIR lens and the projection lens, and may be composed of one lens or three or more lenses that are arranged in the direction of the light axis of the optical system 2.

In FIGS. 2 to 3, because the TIR lens 21-1 is included in the optical system 2-1 and is also included in the optical system 2, the reference numerals of the optical system 2-1 and the optical system 2 are indicated along with the reference numeral of the TIR lens 21-1. This also applies to the TIR lenses 21-2 to 21-9. Moreover, because the projection lens 22-1 is included in the optical system 2-1 and is also included in the optical system 2, the reference numerals of the optical system 2-1 and the optical system 2 are indicated along with the reference numeral of the projection lens 22-1. This also applies to the projection lenses 22-2 to 22-9.

In this embodiment, the shade member 3 is located between the TIR lens 21-1 and the projection lens 22-1, and between the TIR lens 21-5 and the projection lens 22-5. The shade member 3 is situated between the TIR lens 21-9 and the projection lens 22-9. The shade member 3 can control the first light distribution of the optical system 2-1 by shading a part of light passing between the TIR lens 21-1 and the projection lens 22-1. For example, the shade member 3 can generate the light distribution of a low beam by shading a half of light that is on the upper side in the vertical direction (here, corresponding to the Y direction). In this embodiment, a state of shading by the shade member 3 is included in factors of controlling light distribution, and thus it is possible to increase the variety of light distributions that can be generated. The shade member 3 may include a plurality of shade members arranged with spacings, such as one that is located between the TIR lens 21-1 and the projection lens 22-1, one that is located between the TIR lens 21-5 and the projection lens 22-5, one that is located between the TIR lens 21-9 and the projection lens 22-9, and the like. In addition, the vehicular lamp 100 does not need to include the shade member 3 as long as the light distribution of a low beam can be generated using the shape of the housing containing the plurality of optical systems 2, the shape of the TIR lens 21-1, and the like.

As described above, in this embodiment, the plurality of light emitting devices 1 including the light emitting device 1-1 and the light emitting device 1-5 and capable of being driven individually, and the plurality of optical systems including the optical system 2-1 and the optical system 2-5 are included. Light having the first light distribution is emitted from the optical system 2-1 based on light that is incident thereon from the light emitting device 1-1, and light having the second light distribution is emitted from the optical system 2-5 based on light that is incident thereon from the light emitting device 1-5. The light emitting area of the light emitting device 1-1 is different from the light emitting area of the light emitting device 1-5. Moreover, the light distribution angle of the first light distribution is different from the light distribution angle of the second light distribution. In this embodiment, the vehicular lamp 100 emits light having the first light distribution generated by the pair of the light emitting device 1-1 and the optical system 2-1, and light having the second light distribution generated by the pair of the light emitting device 1-5 and the optical system 2-5, and thus can emit light of a greater variety of light distributions, compared to a case where the number of either or both of the light emitting device and the optical system is one. For example, the vehicular lamp 100 can emit light of at least three types of light distributions by driving only the light emitting device 1-1 to emit only light having the first light distribution, driving only the light emitting device 1-5 to emit only light having the second light distribution, driving the light emitting device 1-1 and the light emitting device 1-5 in parallel to emit light in which light having the first light distribution and light having the second light distribution overlap, and the like. Furthermore, by varying the luminosity between the light distribution of the light emitting device 1-1 and the light distribution of the light emitting device 1-5, it is possible to exhibit a greater variety of light distributions. It is possible to adjust the luminosity of a light distribution, by, for example, controlling the amount of an electrical current to be input into the light emitting device, controlling the duty ratio of the driving time, and the like. In this way, in the present embodiment, it is possible to provide the vehicular lamp 100 having a good variety of light distributions.

Further, the present embodiment includes the light emitting device 1-9 that can be driven individually and the optical system 2-9 that generates light having the third light distribution based on light that is incident thereon from the light emitting device 1-9. The light emitting areas of the light emitting device 1-1, the light emitting device 1-5, and the light emitting device 1-9 are different from each other. Moreover, the light distribution angles of the first light distribution, the second light distribution, and the third light distribution are different from each other. In the present embodiment, by providing three pairs of light emitting devices 1 and optical systems 2 that distribute light differently from each other, it is possible to increase the diversity of the light distribution, compared to a case where the vehicular lamp 100 includes two pairs of light emitting devices 1 and optical systems 2 that distribute light differently from each other. The number of pairs of light emitting devices 1 and optical systems 2 included in the vehicular lamp 100 is not limited to two or three, and may be four or greater. The greater the number of pairs of light emitting devices 1 and optical systems 2 that distribute light differently from each other, the greater the variety of the light distribution of the vehicular lamp 100.

The first light emitting device may be a light emitting device other than the light emitting device 1-1 of the plurality of light emitting devices 1, as long as such other light emitting device has a light emitting surface having a light emitting area larger than that of the light emitting surface of the second light emitting device. The second light emitting device may be a light emitting device other than the light emitting device 1-5 of the plurality of light emitting devices 1, as long as such other light emitting device has a light emitting surface having a light emitting area larger than that of the light emitting surface of the third light emitting device. The plurality of light emitting devices 1 include at least the first light emitting device and the second light emitting device. In the vehicular lamp 100, among the plurality of light emitting devices 1, at least the light emitting area of the first light emitting device and the light emitting area of the second light emitting device are different from each other.

The first optical system may be an optical system other than the optical system 2-1 of the plurality of optical systems 2, as long as such other optical system emits light having the first light distribution at a light distribution angle wider than the light distribution angle of the second light distribution of the second optical system. The second optical system may be an optical system other than the optical system 2-5 of the plurality of optical systems 2, as long as such other optical system emits light having the second light distribution at a light distribution angle wider than the light distribution angle of the third light distribution of the third optical system. The plurality of optical systems 2 include at least the first optical system and the second optical system. In the vehicular lamp 100, at least the light distribution angle of the first light distribution of the first optical system and the light distribution angle of the second light distribution of the second optical system, of the plurality of optical systems 2, are different from each other.

In this embodiment, the light emitting area of the light emitting device 1-1 may be wider than the light emitting area of the light emitting device 1-5, and the light distribution angle of the first light distribution may be wider than the light distribution angle of the second light distribution. With this configuration, it is possible to efficiently obtain a light distribution with a high luminosity as a narrow-angle light distribution and a light distribution with a low luminosity as a wide-angle light distribution,.

In this embodiment, the light emitting area of the light emitting device 1-5 may be wider than the light emitting area of the light emitting device 1-9, and the light distribution angle of the second light distribution may be wider than the light distribution angle of the third light distribution. With this configuration, it is possible to efficiently obtain a light distribution with a high luminosity as a narrow-angle light distribution, a light distribution with a low luminosity as a wide-angle light distribution, and a light distribution with an intermediate luminosity as a light distribution that is intermediate between the narrow-angle light distribution and the wide-angle light distribution.

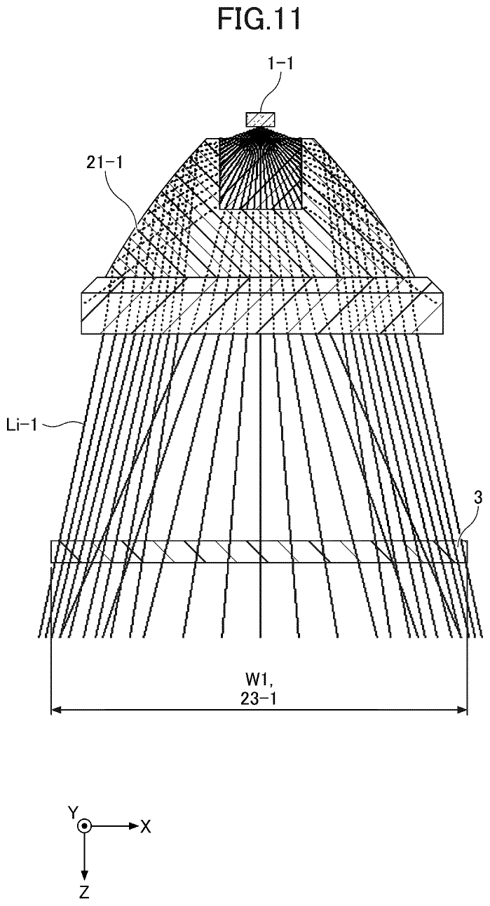

In this embodiment, the TIR lens 21-1 forms a first virtual light source image between the TIR lens 21-1 and the projection lens 22-1 based on light that is incident thereon from the light emitting device 1-1. Here, a virtual light source image refers to a light distribution formed by a TIR lens and shaped by the shade member 3 to function virtually as a point light source or a surface light source. The details of the virtual light source image will be described separately with reference to FIGS. 11 and 12. The position between the TIR lens 21-1 and the projection lens 22-1 at which the first virtual light source image is formed is, for example, a position on the shade member 3. The shade member is located at the focal position of the projection lens 22-1. The projection lens 22-1 outputs light that is incident thereon from the first virtual light source image.

Similarly, the TIR lens 21-5 forms a second virtual light source image between the TIR lens 21-5 and the projection lens 22-5 based on light that is incident thereon from the light emitting device 1-5. The projection lens 22-5 outputs light that is incident thereon from the second virtual light source image. The TIR lens 21-9 forms a third virtual light source image between the TIR lens 21-9 and the projection lens 22-9 based on light that is incident thereon from the light emitting device 1-9. The projection lens 22-9 outputs light that is incident thereon from the third virtual light source image.

With the TIR lens 21-1 forming the first virtual light source image and the projection lens 22-1 outputting the light incident from the first virtual light source image, the shapes, positioning, and the like of the TIR lens 21-1 and the projection lens 22-1 can be included in factors of controlling light distribution. Thus, in this embodiment, it is possible to increase the variety of light distributions that can be generated, compared to a case where light from the light emitting device 1 is output via only one lens. Moreover, with the TIR lens 21-1 forming the first virtual light source image within the projection lens 22-1 and causing the divergence of light beams emitted from the first virtual light source image to be within the size of the projection lens 22-1 when viewed in a top view, it is possible to reduce leakage light. Thus, the light utilization efficiency of the vehicular lamp 100 can be increased. The same effect can be obtained from the pair of the TIR lens 21-5 and the projection lens 22-5 and the pair of the TIR lens 21-9 and the projection lens 22-9.

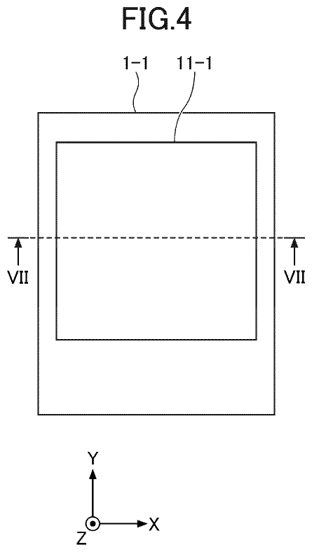

On the other hand, unless a light emitting device is positioned on the light axis of a lens configured to output light from the light emitting device, there may be a case where the length of the vehicular lamp in the direction crossing the light axis is increased. For example, in FIG. 4 of PTL 1, there is one projection lens, and accordingly there may be a case where the light emitting device fails to be positioned on the light axis of a lens group, and the length of the vehicular lamp in the direction crossing the light axis may be increased.

In this embodiment, as shown in FIG. 3, a light axis A1 of the TIR lens 21-1 and a light axis A2 of the projection lens 22-1 are positioned on a first straight line LN1. The light emitting device 1-1 is positioned on the first straight line LN1. A light axis A3 of the TIR lens 21-5 and a light axis A4 of the projection lens 22-5 are positioned on a second straight line LN2. The light emitting device 1-5 is positioned on the second straight line LN2. With this configuration, it is possible to shorten the length of the vehicular lamp 100 in the direction intersecting the light axis A1, and to reduce the thickness of the vehicular lamp 100.

In this embodiment, a light axis A5 of the TIR lens 21-9 and a light axis A6 of the projection lens 22-9 are positioned on a third straight line LN3, and the light emitting device 1-9 is positioned on the third straight line LN3. With this configuration, it is possible to shorten the length of the vehicular lamp 100 in the direction crossing the light axis A5, and to reduce the thickness of the vehicular lamp 100.

In FIG. 3, because the first straight line LN1, the light axis A1, and the light axis A2 coincide, the reference numerals of the light axis A1 and the light axis A2 are indicated along with the reference numeral of the first straight line LN1. Similarly, because the second straight line LN2, the light axis A3, and the light axis A4 coincide, the reference numerals of the light axis A3 and the light axis A4 are indicated along with the reference numeral of the second straight line LN2 in FIG. 3. Because the third straight line LN3, the light axis A5, and the light axis A6 coincide, the reference numerals of the light axis A5 and the light axis A6 are indicated along with the reference numeral of the third straight line LN3 in FIG. 3.

In this embodiment, the plurality of light emitting devices 1 are arranged in a one-dimensional grid form, and the plurality of optical systems 2 are arranged in a one-dimensional grid form. Arranging the plurality of light emitting devices 1 and the plurality of optical systems 2 in the one-dimensional grid form can facilitate manufacture of the vehicular lighting fixture 100. In addition, regularly arranging the plurality of light emitting devices 1 and the plurality of optical systems 2 facilitates prediction of a light distribution obtained by superimposing a plurality of light distributions. As a result, according to this embodiment, it is easy to control the light distributions of the vehicular lighting fixture 100. The plurality of light emitting devices 1 and the plurality of optical systems 2 may be arranged not only in a one-dimensional grid form but also in a two-dimensional grid form. In this case, the same effect as in the case of the one-dimensional grid form can be obtained. However, the plurality of light emitting devices 1 and the plurality of optical systems 2 may be arranged in any arrangement other than a grid form.

### <Configuration Example of Light Emitting Device 1>

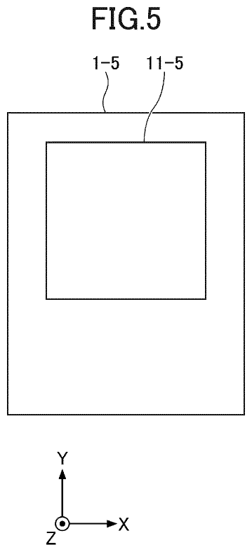

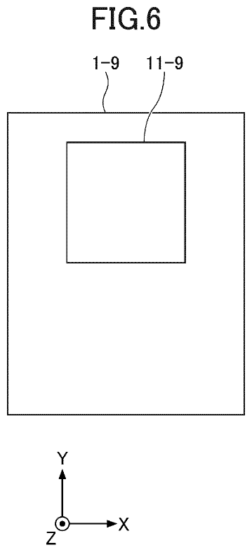

The configuration of the light emitting device 1 will be described in detail with reference to FIGS. 4 to 7. FIG. 4 is a schematic top view showing an example of the light emitting device 1-1 as the first light emitting device. FIG. 5 is a schematic top view showing an example of the light emitting device 1-5 as the second light emitting device. FIG. 6 is a schematic top view showing an example of the light emitting device 1-9 as the third light emitting device.

As shown in FIGS. 4 to 6, the light emitting areas of the light emitting device 1-1, the light emitting device 1-5, and the light emitting device 1-9 are different from one another. For example, the light emitting area of the light emitting surface 11-1 of the light emitting device 1-1, the light emitting area of the light emitting surface 11-5 of the light emitting device 1-5, and the light emitting area of the light emitting surface 11-9 of the light emitting device 1-9 are different from one another. In the example shown in FIGS. 4 to 6, the light emitting area of the light emitting device 1-1 is larger than the light emitting area of the light emitting device 1-5. The light emitting area of the light emitting device 1-5 is larger than the light emitting area of the light emitting device 1-9. The area of the light emitting surface 11-1 of the light emitting device 1-1 may be 1.2 times or greater and 1.8 times or less, and preferably 1.4 times or greater and 1.6 times or less the area of the light emitting surface 11-5 of the light emitting device 1-5. The area of the light emitting surface 11-1 of the light emitting device 1-1 may be 1.8 times or greater and 2.7 times or less, and preferably 2.1 times or greater and 2.4 times or less the area of the light emitting surface 11-9 of the light emitting device 1-9. The area of the light emitting surface 11-5 of the light emitting device 1-5 may be 1.2 times or greater and 1.8 times or less, and preferably 1.4 times or greater and 1.6 times or less the area of the light emitting surface 11-9 of the light emitting device 1-9. The area of the light emitting surface 11-1 of the light emitting device 1-1 may be, for example, 1.0 mm² or greater and 1.5 mm² or less, and may be 1.17 mm² or greater and 1.33 mm² or less. The area of the light emitting surface 11-5 of the light emitting device 1-5 may be, for example, 0. 67 mm² or greater and or less than 1.0mm² , and may be 0.78 mm² or greater and 0.89 mm² or less. The area of the light emitting surface 11-9 of the light emitting device 1-9 may be, for example, 0.44 mm² or greater and less than 0.67 mm² , and may be 0.52 mm² or greater and 0.59 mm² or less.

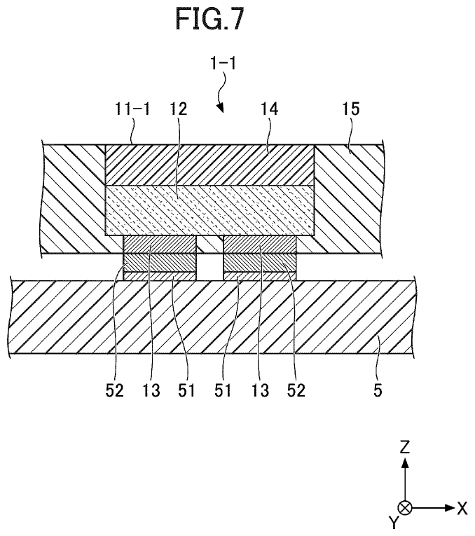

FIG. 7 is a schematic cross-sectional view of the light emitting device 1-1. FIG. 7 shows a cross-section of the light emitting device 1-1 taken along a VII-VII cutting line of FIG. 4. The cross-sections of the plurality of light emitting devices 1 including the light emitting device 1-5 and the light emitting device 1-9 are the same as the cross-section of the light emitting device 1-1, except for the light emitting area of the light emitting surface. Therefore, duplicate descriptions thereof will be omitted here.

As shown in FIG. 7, the light emitting device 1-1 is arranged on the +Z-side surface of a substrate 5 with its +Z-side surface serving as the light emitting surface 11-1 and its surface opposite to the light emitting surface 11-1 serving as the mounting surface. The light emitting device 1-1 includes a light emitting element 12, a wavelength conversion member 14 arranged on the light emitting element 12, and a light shielding member 15 covering the lateral surfaces and the bottom surface of the light emitting element 12 and the lateral surfaces of the wavelength conversion member 14. In the example shown in FIG. 7, the wavelength conversion member 14 is provided on the +Z-side surface of the light emitting element 12. The light shielding member 15 covers the lateral surfaces and the bottom surface of the light emitting element 12 and the lateral surfaces of the wavelength conversion member 14 except for the +Z-side surface of the wavelength conversion member 14. In the light emitting device 1-1, the lateral surfaces of the wavelength conversion member 14 may be covered with the light shielding member 15.

The light shielding member 15 may be provided between adjacent light emitting devices 1 of the plurality of light emitting devices 1, and may integrally support the plurality of light emitting elements 12 and the plurality of wavelength conversion members 14. With this configuration, it is possible to mount the plurality of light emitting devices 1 collectively or to narrow the distance between the light emitting devices 1.

It is preferable to provide at least a pair of positive and negative electrodes 13 (e.g., a p-side electrode and an n-side electrode) on the surface of the light emitting element 12 opposite to the light emitting surface 11. In this embodiment, the outer shape of the light emitting surface 11-1 in a top view is substantially rectangular. However, the outer shape of the light emitting surface 11-1 in a top view may be substantially circular or substantially elliptical, or polygonal, such as substantially triangular or substantially hexagonal.

It is preferable that the light emitting element 12 is made of various semiconductors, such as Group III-V compound semiconductors, Group II-VI compound semiconductors, and the like. As the semiconductor, it is preferable to use a nitride semiconductor, such as InₓAl_{y}Ga_{1-X-Y}N (0≤X, 0≤Y, X+Y≤1) and the like, and it is also possible to use InN, AlN, GaN, InGaN, AlGaN, InGaAlN, and the like. The light emitting element 12 is, for example, an LED or a Laser Diode (LD). The light emitting peak wavelength of the light emitting element 12 is preferably 400 nm or greater and 530 nm or less, more preferably 420 nm or greater and 490 nm or less, and more preferably 450 nm or greater and 475 nm or less from the viewpoint of light emission efficiency, excitation of a below-described wavelength conversion substance, and the like. The light emitting peak wavelength of the light emitting element 12 is not limited to the above range, and may be, for example, greater than 530 nm and 800 nm or less.

The wavelength conversion member 14 is a member having, for example, a substantially rectangular outer shape in a top view. The wavelength conversion member 14 is provided to cover the upper surface of the light emitting element 12. The wavelength conversion member 14 can be made of a light-transmissive resin material, and an inorganic material, such as a ceramic, glass, and the like. As the resin material, a thermosetting resin, such as silicone resin, silicone-modified resin, epoxy resin, epoxy-modified resin, phenol resin, and the like can be used. Especially, silicone resin that has good light resistance and heat resistance, or its modified resin is preferable. As used herein, the light transmissivity is preferably a property of transmitting 60% or more of the light from the light emitting element 12. As the wavelength conversion member 14, a thermoplastic resin, such as polycarbonate resin, acrylic resin, methylpentene resin, or polynorbornene resin, or the like can be used. Furthermore, the wavelength conversion member 14 contains a wavelength conversion substance that converts the wavelength of at least a part of light from the light emitting element 12 within the resin described above. For example, the wavelength conversion member 14 may be a resin material, a ceramic, glass, or the like containing the wavelength conversion substance, a sintered body of the wavelength conversion substance, or the like. Further, the wavelength conversion member 14 may be a multilayered member obtained by arranging a resin layer containing the wavelength conversion substance on the ±Z-side surface of a molding of a resin, a ceramic, glass, or the like.

Examples of the wavelength conversion substance contained in the wavelength conversion member 14 include yttrium-aluminum-garnet-based phosphors (for example, (Y, Gd)₃(Al, Ga)₅O₁₂:Ce); lutetium-aluminum-garnet-based phosphors (for example, Lu₃(Al, Ga)₅O₁₂:Ce) ; terbium-aluminum-garnet-based phosphors (for example, Tb₃(Al, Ga)₅O₁₂:Ce) ; CCA-based phosphors (for example, Ca₁₀(PO₄)₆Cl₂:Eu); SAE-based phosphors (for example, Sr₄Al₁₄O₂₅:Eu) ; chlorosilicate-based phosphors (for example, Ca₈MgSi₄O₁₆Cl₂:Eu) ; silicate-based phosphors (for example, (Ba,Sr,Ca,Mg)₂SiO₄:Eu) ; oxynitride-based phosphors such as B-sialon-based phosphors (for example, (Si,Al)₃(O,N)₄:Eu), x-sialon-based phosphors (for example, Ca(Si, Al)₁₂(O,N)₁₆:Eu), and the like; nitride-based phosphors such as LSN-based phosphors (for example, (La,Y)₃Si,N₁₁:Ce ), BSESN-based phosphors (for example, (Ba,Sr)₂Si₅N₈:Eu), SLA-based phosphors (for example, SrLiAl₃N₄:Eu), CASN-based phosphors (for example, CaAlSiN₃:Eu), SCASN-based phosphors (for example, (Sr,Ca)AlSiN₃:Eu), and the like; fluoride-based phosphors, such as KSF-based phosphors (for example, K₂SiF₆:Mn), KSAF-based phosphors (for example, K₂(Si₁₋ₓAlₓ)F₆₋ₓ:Mn where x satisfies 0<x<1), MGF-based phosphors (for example, 3.5 MgO·0.65MgF₂#GeO₂:Mn), and the like; quantum dots having a perovskite structure (for example, (Cs,FA,MA)(Pb,Sn)(F,Cl,Br,I)₃ where FA and MA represent formamidinium and methylammonium, respectively) ; Group II-VI quantum dots (for example, CdSe) ; Group III-V quantum dots (for example, InP); quantum dots having a chalcopyrite structure (for example, (Ag,Cu)(In,Ga)(S,Se)₂); and the like. The wavelength conversion substance is particulate. One of these wavelength conversion substances can be used alone, or two or more of these wavelength conversion substances can be used in combination.

In the embodiment, a blue light emitting element is used as the light emitting element 12 in the light emitting device 1-1, and the wavelength conversion member 14 the wavelength conversion substance that converts wavelength of light emitted from the light emitting element 12 into yellow, so that white light is emitted. The wavelength conversion member 14 may contain a light scattering substance. As the light scattering substance, for example, titanium oxide, barium titanate, aluminum oxide, silicon oxide, or the like can be used. A green light emitting element or a red light emitting element may be used as the light emitting element 12. The color of the light emitted by the light emitting device 1-1 is not limited to white, and may be, for example, visible light.

The light shielding member 15 is a member that covers the lateral surfaces and the bottom surface of the light emitting element 12 and the lateral surfaces of the wavelength conversion member 14. The light shielding member 15 directly or indirectly covers the lateral surfaces of the light emitting element 12 and the wavelength conversion member 14. With this configuration, light to be leaked through the lateral surfaces of the light emitting element 12 and the lateral surfaces of the wavelength conversion member 14 is reduced, so that the extraction efficiency of light emitted from the light emitting element 12 can be improved. The upper surface of the wavelength conversion member 14 is exposed from the light shielding: member 15 and serves as the light emitting surface 11-1 of the light emitting device 1-1. The light shielding member 15 is located between adjacent light emitting devices 1 of the plurality of light emitting devices 1, and may separate adjoining light emitting devices 1 from each other. In order to improve the light extraction efficiency, it is preferable that the light shielding member 15 is composed of a member having a high light reflectance. As the light shielding member 15, for example, a resin material containing a light scattering substance, such as a white pigment and the like, can be used.

Examples of the light scattering substance include titanium oxide, zinc oxide, magnesium oxide, magnesium carbonate, magnesium hydroxide, calcium carbonate, calcium hydroxide, calcium silicate, magnesium silicate, barium titanate, barium sulfate, aluminum hydroxide, aluminum oxide, zirconium oxide, silicon oxide, and the like. It is preferable to use one of these alone, or two or more of these in combination. As the resin material, it is preferable that a resin material mainly composed of a thermosetting resin, such as epoxy resin, epoxy-modified resin, silicone resin, silicone-modified resin, phenol resin, and the like, is used as a base material.

The light emitting device 1-1 is electrically connected to a wiring 51 provided on the substrate 5. It is preferable that the substrate 5 has the wiring 51 that is provided on the surface. The substrate 5 may include the wiring 51 inside it. The light emitting device 1-1 and the substrate 5 are electrically connected through connection of the wiring 51 of the substrate 5 to the at least one pair of positive and negative electrodes 13 of the light emitting device 1-1 via a conductive adhesive member 52. The configuration, the size, and the like of the wiring 51 of the substrate 5 are set in accordance with the configuration and the size of the electrodes 13 of the light emitting device 1-1.

It is preferable that an insulating material is used as the base material of the substrate 5, and it is preferable to use a material that does not easily transmit light emitted from the light emitting device 1-1, external light, and the like, and to use a material having a certain strength. Specifically, the base material of the substrate 5 may be composed of a ceramic, such as alumina, aluminum nitride, mullite, silicon nitride, or the like, and a resin, such as phenol resin, epoxy resin, polyimide resin, bismaleimide triazine resin (BT resin), polyphthalamide, polyester resin, or the like.

The wiring 51 may be composed of at least one of copper, iron, nickel, tungsten, chromium, aluminum, silver, gold, titanium, palladium, rhodium, alloys thereof, or the like. Further, a layer of silver, platinum, aluminum, rhodium, gold, alloys thereof, or the like may be provided as the surface layer of the wiring 51 from the viewpoint of wettability and/or light reflectivity, and the like of the conductive adhesive member 52.

### <Configuration Example of TIR Lenses 21-1 to 21-9>

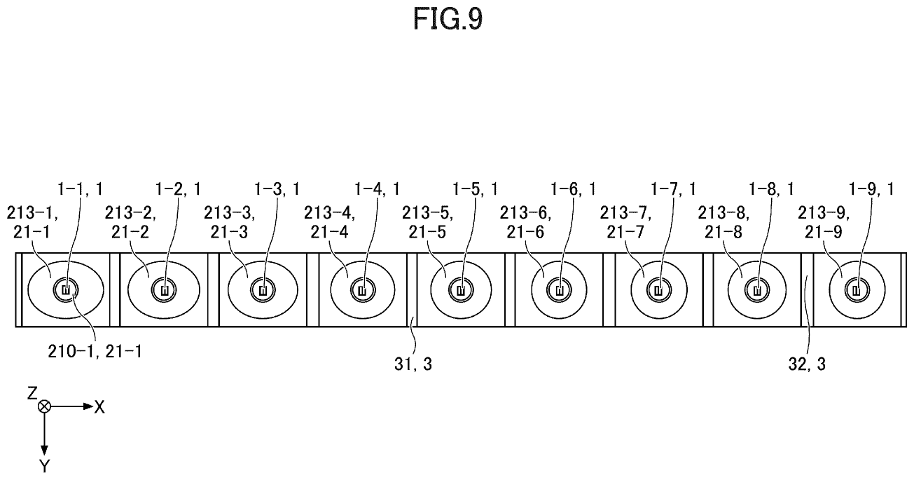

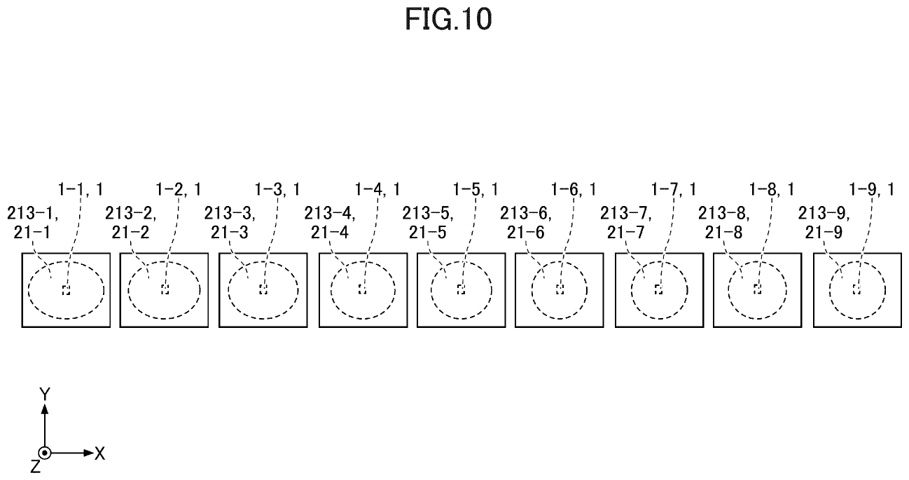

The configuration of the TIR lenses 21-1 to 21-9 will be described in detail with reference to FIGS. 8 to 10. FIG. 8 is a schematic cross-sectional view of the TIR lens 21-1 in FIG. 3. FIG. 8 schematically shows a cross-section along a VIII-VIII cutting line in FIG. 3. FIGS. 9 and 10 are views showing an example of the TIR lenses 21-1 to 21-9. FIG. 9 is a bottom view and FIG. 10 is a top view.

As shown in FIGS. 8 to 10, the TIR lens 21-1 has a recessed part 210-1, a first light incident part 211-1, a second light incident part 212-1, a reflecting part 213-1, and a light outputting part 214.

As shown in FIG. 8, the recessed part 210-1 is a recess extending in a direction away from the light emitting device 1-1 from a position, in the TIR lens 21-1, that is close to the light emitting device 1-1. As shown in FIG. 9, the recessed part 210-1 has a substantially circular outer shape in a bottom view. The light emitting device 1-1 is positioned within the recessed part 210-1 in a bottom view.

As shown in FIG. 8, the inner wall surface of the recessed part 210-1 includes the first light incident part 211-1. The bottom surface of the recessed part 210-1 includes the second light incident part 212-1. In the TIR lens 21-1, each of the first light incident part 211-1 and the second light incident part 212-1 is a part through which light emitted from the light emitting device 1-1 enters the interior of the TIR lens 21-1.

As shown in FIGS. 8 and 9, the outer wall surface of the TIR lens 21-1 includes the reflecting part 213-1. In the example shown in FIG. 8, the reflecting part 213-1 has a substantially bowl-like shape including a curved surface. However, the reflecting part 213-1 is not limited to a substantially bowl-like shape, and may have a substantially conical shape and the like. As shown in FIG. 9, the reflecting part 213-1 is located outside the recessed part 210-1 in a bottom view. The reflecting part 213-1 is a part that mainly reflects light incident into the interior of the TIR lens 21-1 through the first light incident part 211-1. From the viewpoint of increasing the light utilization efficiency of the TIR lens 21-1, it is preferable that the reflecting part 213-1 is formed so as to totally reflect light incident into the interior of the TIR lens 21-1 through the first light incident part 211-1.

As shown in FIG. 8, the light outputting part 214 is configured such that light incident into the interior of the TIR lens 21-1 through the first light incident part 211-1 and the second light incident part 212-1 and then reaching the light outputting part 214 without reaching the reflecting part 213-1 is output to outside the TIR lens 21-1. The light outputting part 214 is configured such that light incident into the interior of the TIR lens 21-1 mainly through the first light incident part 211-1, reflected by the reflecting part 213-1, and then reaching the light outputting part 214 is output to outside the TIR lens 21-1. The light output from the light outputting part 214 reaches the shade member 3 or the projection lens 22-1 shown in FIG. 3.

For example, in the TIR lens 21-1, spreading angle, i.e., a light distribution angle of the light to be output from the light outputting part 214 can be determined by determining the shape of the reflecting part 213-1, such as the radius of curvature. Similarly, in the TIR lenses 21-2 to 21-9, a light distribution angle of the light to be output can be determined by determining the shape, such as the radius of curvature, of reflecting parts 213-2 to 213-9.

As shown in FIG. 10, in this embodiment, in a top view, the area of the reflecting part 213-1 is different from the area of the reflecting part 213-5. Here, the reflecting part 213-1 is an example of a first reflecting part. The reflecting part 213-5 is an example of a second reflecting part. The first light distribution using the TIR lens 21-1 including the reflecting part 213-1 and the second light distribution using the TIR lens 21-5 including the reflecting part 213-5 are different light distributions due to the difference in the area of the reflecting parts. Thus, in this embodiment, including the area of the reflecting part in factors of controlling the light distribution, it is possible to increase the variety of light distributions that can be generated.

The area of the reflecting part 213-1 is larger than the area of the reflecting part 213-5. The area of the reflecting part 213-1 is larger than the area of the reflecting part 213-9. The area of the reflecting part 213-1 may be 1.1 times or greater and 1.4 times or less, and preferably 1.2 times or greater and 1.3 times or less the area of the reflecting part 213-5. The area of the reflecting part 213-1 may be 1.2 times or greater and 1.5 times or less, and preferably 1.3 times or greater and 1.4 times or less the area of the reflecting part 213-9. The area of the reflecting part 213-5 is larger than the area of the reflecting part 213-9. The area of the reflecting part 213-5 may be 1.1 times or greater and 1.4 times or less, and preferably 1.2 times or greater and 1.3 times or less the area of the reflecting part 213-9.

In this embodiment, in a top view, the outer shape of the reflecting part 213-1 is elliptical, and the outer shape of the reflecting part 213-5 is circular. Thus, in this embodiment, by varying the outer shapes of the reflecting parts in a top view, it is possible to vary the areas of the reflecting parts and vary the light distributions. In this embodiment, by including the ellipticity of the outer shape of the reflecting part in a top view among the light distribution control factors, it is possible to increase the variety of light distributions that can be generated. The ellipticity of the reflecting part 213-1 is greater than the ellipticity of the reflecting part 213-5. The ellipticity of the reflecting part 213-1 is greater than the ellipticity of the reflecting part 213-9. The ellipticity of the outer shape of the reflecting part 213-1 may be 1.1 times or greater and 1.4 times or less, and preferably 1.2 times or greater and 1.3 times or less the ellipticity of the reflecting part 213-5. The ellipticity of the outer shape of the reflecting part 213-1 may be 1.2 times or greater and 1.5 times or less, and preferably 1.3 times or greater and 1.4 times or less the ellipticity of the reflecting part 213-9. The ellipticity of the reflecting part 213-5 is greater than the ellipticity of the reflecting part 213-9. The ellipticity of the outer shape of the reflecting part 213-5 may be 1.1 times or greater and 1.4 times or less, and preferably 1.2 times or greater and 1.3 times or less the ellipticity of the reflecting part 213-9.

In this embodiment, in a top view, the outer shape of either the reflecting part 213-1 of the TIR lens 21-1 or the reflecting part 213-5 of the TIR lens 21-5 may conform to the outer shape of the vehicular lamp 100 shown in FIG. 1. As used herein, “conforming to the outer shape” means having substantially the same shape as the outer shape or having a shape that is substantially similar to the outer shape. As shown in FIG. 1, the outer shape of the vehicular lamp 100 in a top view is substantially rectangular. Therefore, in this example, the outer shape of either the reflecting part 213-1 or the reflecting part 213-5 can be formed to conform to substantially a rectangular shape. Forming the outer shape of either the reflecting part 213-1 or the reflecting part 213-5 in a top view to conform to the outer shape of the vehicular lamp 100 allows for facilitating the user of the vehicular lamp 100 to predict the outer shape of the light illumination by the vehicular lamp 100, so that the usability of the vehicular lamp 100 can be improved.

In FIG. 9, the shade member 3 is located on the +Z side of the TIR lenses 21-1 to 21-9. The shade member 3 is positioned to overlap at least a part of the first virtual light source formed by the TIR lens 21-1. The shade member 3 is positioned to overlap at least a part of the second virtual light source formed by the TIR lens 21-5. In other words, the TIR lens 21-1 forms the first virtual light source to overlap at least a part of the first virtual light source with the shade member 3. The TIR lens 21-5 forms the second virtual light source to overlap at least a part of the second virtual light source with the shade member 3. With these configurations, in this embodiment, a shaded state of the first virtual light source or the second virtual light source generated by the shade member 3 can be included in factors of controlling light distribution, and the variety of light distributions that can be generated can be increased.

In the example shown in FIG. 9, the shade member 3 includes a first shade member 31 and a second shade member 32. The first shade member 31 and the second shade member 32 extend in the X direction in which the TIR lenses 21-1 to 21-9 are arranged. In a bottom view, the first shade member 31 overlaps with an approximately half of regions of the TIR lenses 21-1 to 21-9 on the +Y side. In a bottom view, the second shade member 32 overlaps with approximately a half of each of regions of the TIR lenses 21-8 and 21-9 on the +Y side and approximately a half of each of them on the −Y side, except for the central parts of the TIR lenses 21-8 and 21-9 in the Y direction.

With the first shade member 31 shading approximately a half, on the +Y side, of the virtual light sources formed by the TIR lenses 21-1 to 21-9, the vehicular lamp 100 can generate light for light distribution of a low beam, which is light shaded by approximately a half thereof on the +Y side.

The first shade member 31 and the second shade member 32 shade approximately halves, on the +Y side and the −Y side, of the virtual light sources formed by the TIR lenses 21-1 to 21-9 except for the central part in the Y direction. Thus, the vehicular lamp 100 can reduce glare of light from the TIR lenses 21-1 to 21-9.

The light distribution pattern includes a variety of patterns depending on the combination of the light emitting area of the light emitting device and the area of the reflecting part of the TIR lens. When using a shade member, light distribution also depends on the area of a part to be shaded by the shade member. That is, the types of light distributions have a greater variety than that of the types of the light emitting areas of the light emitting devices.

### <Example of Virtual Light Source Image>

A virtual light source image obtained in the vehicular lamp 100 will be described with reference to FIGS. 11 and 12. FIG. 11 is a view for explaining the first virtual light source image. FIG. 12 is a view for explaining the second virtual light source image.

In FIG. 11, the TIR lens 21-1 outputs propagating light Li-1 based on light that is incident thereon from the light emitting device 1-1. In FIG. 11, a plurality of straight lines corresponding to the propagating light Li-1 schematically represent a plurality of rays emitted from the light emitting device 1-1 and output from the TIR lens 21-1 through the interior of the TIR lens 21-1.

In this embodiment, the TIR lens 21-1 outputs light emitted from the light emitting device 1-1 by diverging the light. The TIR lens 21-1 causes the propagating light Li-1 to form a first virtual light source image 23-1 such that a part of the first virtual light source image 23-1 overlaps the shade member 3. In a top view, the TIR lens 21-1 has a substantially elliptical outer shape of which the longer axis is in the X direction. Therefore, the first virtual light source image 23-1 is a substantially elliptical image of which the longer axis has a length W1 in a top view.

On the other hand, in FIG. 12, the TIR lens 21-5 outputs propagating light Li-5 based on light that is incident thereon from the light emitting device 1-5. In FIG. 12, a plurality of straight lines corresponding to the propagating light Li-5 schematically represent a plurality of rays emitted from the light emitting device 1-5 and output from the TIR lens 21-5 through the interior of the TIR lens 21-5.

In this embodiment, the TIR lens 21-5 condenses light from the light emitting device 1-5 and outputs it. The TIR lens 21-5 causes the propagating light Li-5 to form a second virtual light source image 23-5 such that a part of the second virtual light source image overlaps the shade member 3. Because the TIR lens 21-5 has a substantially circular outer shape in a top view, the second virtual light source image 23-5 is a substantially circular image of which the length corresponding to the diameter is W5 in a top view.

As shown in FIGS. 11 and 12, the length W1 of the first virtual light source image 23-1 is longer than the length W5 of the second virtual light source image 23-5. The longer the length of a virtual light source image, the wider the light distribution angle of light projected by a projection lens after being incident on the projection lens from the virtual light source image. In the example shown in FIGS. 11 and 12, the longer the length of a virtual light source image in the X direction, the wider the light distribution angle of light projected by a projection lens after being incident on the projection lens from the virtual light source image. Therefore, the light distribution angle of light projected by the projection lens 22-1 shown in FIG. 3 after being incident thereon from the first virtual light source image 23-1 is wider than the light distribution angle of light projected by the projection lens 22-5 after being incident thereon from the second virtual light source image 23-5. In other words, the combination including the light emitting device 1-1 and the optical system 2-1 shown in FIG. 3 can output light having a wider-angle light distribution, as compared with the combination including the light emitting device 1-5 and the optical system 2-5. The combination including the light emitting device 1-5 and the optical system 2-5 can output light having a narrower-angle light distribution, as compared with the combination including the light emitting device 1-1 and the optical system 2-1.

In this embodiment, the TIR lens 21-1 diverges light from the light emitting device 1-1 and outputs the light, and the TIR lens 21-5 condenses light from the light emitting device 1-5 and outputs the light. For example, if only TIR lenses that condense light from the light emitting devices and output the light are used, when the condensing position of the light is varied among the plurality of TIR lenses in order to exhibit a variety of light distributions, the amount of leakage light, which is light that cannot enter the projection lenses from the TIR lenses, may be increased depending on the condensing position. For example, if the condensing position of light from a TIR lens is too close to the TIR lens, the light from the TIR lens spreads until it reaches the projection lens, resulting in increase in the leakage light. If leakage light increases, the position to which light is condensed by a TIR lens might be restricted, and diversification of light distributions might be inhibited. In this embodiment, for example, if the amount of leakage light of condensed light output from a specific TIR lens would be large, the TIR lens can be configured to output divergent light instead of condensed light. Thus, it is possible to increase the light utilization efficiency of the vehicular lamp by reducing leakage light, and to obtain a variety of light distributions by reducing the restrictions associated with the condensing position.

### <Example of Light Distribution by Vehicular Lamp According to First Embodiment>

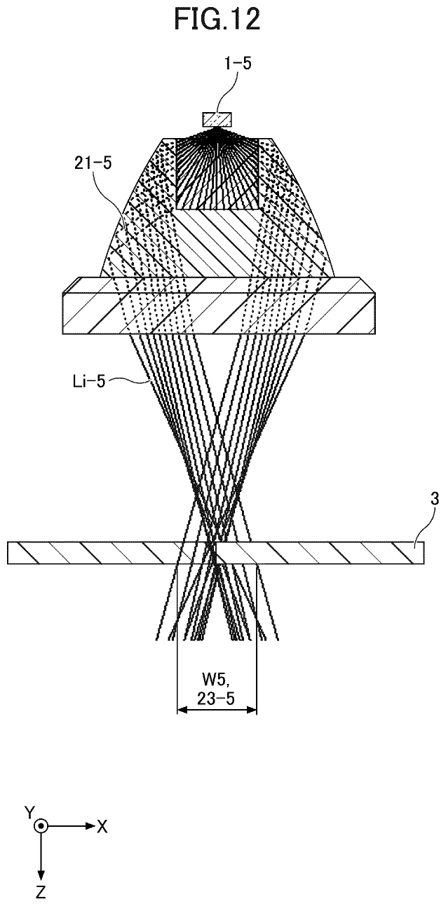

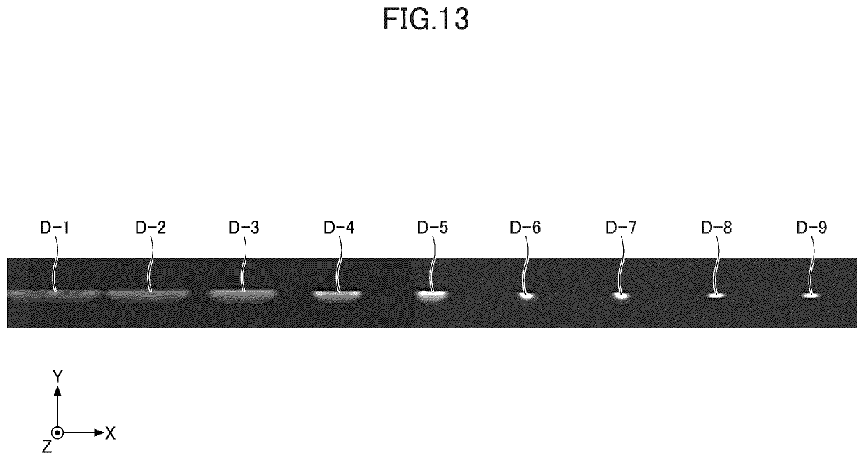

FIG. 13 is a diagram showing an example of light distributions obtained by the vehicular lamp according to this embodiment. In FIG. 13, light distributions D-1 to D-9 arranged in the X direction represent, as a top view, the images corresponding to the light distributions of the light output from the optical systems 2-1 to 2-9 of FIG. 3. The higher the luminance of the image and the whiter the image appears, the higher the luminosity of the output light. Conversely, the lower the luminance of the image and the darker the image appears, the lower the luminosity of the output light.

The parts, on the +Y side, of the light distributions D-1 to D-9 are shaded by the first shade member 31 shown in FIG. 9 and are almost eliminated. In a top view, the light distribution D-1 has a shape that is longer in the X direction because the longer axis length of the ellipse, which is the outer shape of the reflecting part of the TIR lens, is long and the light distribution angle of the light that is output is wide. In order of the light distributions D-2 to D-7, the longer axis length of the ellipse becomes shorter and the light distribution angle of the light that is output becomes smaller, compared with the light distribution D-1. In the light distributions D-8 and D-9, the light distribution length in the Y direction is even shorter because the part on the −Y side is shaded by the second shade member 32 shown in FIG. 9. In accordance with the lengths in the X direction and in the Y direction, the light distribution area corresponding to the light distribution angle is the widest in the light distribution D-1, and decreases in order of the light distributions D-2 to D-8. The light distribution D-8 and the light distribution D-9 have approximately the same light distribution area. In accordance with the light distribution area, the light distribution angle becomes narrower in order of the light distributions D-1 to D-8, and the light distribution D-8 and the light distribution D-9 have approximately the same light distribution angle.

On the other hand, the luminosity of the output light is the lowest in the light distribution D-1, and increases in order of the light distribution D-2 to D-6. In the light distribution D-6 to D-9, the luminosity is almost the same.

As described above, in this embodiment, it is possible to obtain the light distributions D-1 to D-9 that are different from one another, and to obtain a variety of light distributions. It is possible to combine the light distributions D-1 to D-9 in any appropriate manner, and thus to obtain a variety of light distributions. It is possible to control the luminosity of the light distributions D-1 to D-9, by, for example, controlling the amount of an electrical current to be input into the light emitting device, controlling the duty ratio of the driving time, and the like.

The colors of the light distributions D-1 to D-9 do not need to be white. For example, the light emitted by the light emitting devices 1-1 to 1-9 may be visible light. The light distributions D-1 to D-9 may have one or more colors, two or more colors, and three or more colors, respectively as their

<Relationship between Light Emitting Area of Light Emitting Device 1 and Luminosity of Light Distribution>

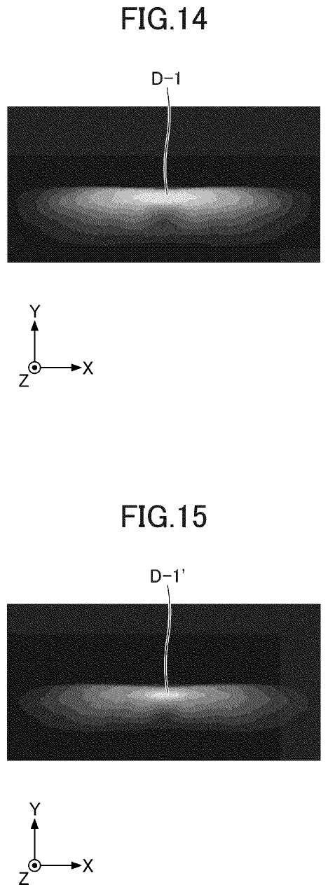

The luminosity of a light distribution may vary depending on the light emitting area of the light emitting surface of a light emitting device 1. Referring to FIGS. 14 to 16, the relationship between the light emitting area of a light emitting device 1 and the luminosity of output light will be described below. Herein, the relationship between the light emitting area of a light emitting device 1 and the luminosity of a light distribution will be described separately for a case of a wide-angle light distribution and a case of a narrow-angle light distribution. Regarding the distinction between a wide-angle light distribution and a narrow-angle light distribution as a light distribution, for example, a light distribution obtained when divergent light is output from the TIR lens is defined as a wide-angle light distribution. Specifically, light distributions corresponding to the light distributions D-1 to D-4 in FIG. 13 are wide-angle light distributions. On the other hand, a light distribution obtained when condensed light is output from the TIR lens is defined as a narrow-angle light distribution. Specifically, light distributions corresponding to the light distribution D-5 to D-9 in FIG. 13 are narrow-angle light distributions.

### (In Case of Wide-angle Light Distribution)

Referring to FIGS. 14 and 15, regarding the light distribution D-1 that has the widest angle among the light distributions D-1 to D-9 shown in FIG. 13, the result of examining how the luminosity of the light distribution differs in accordance with the light emitting area of the light emitting surface of the light emitting device 1-1 will be described.

FIG. 14 is a first drawing showing the relationship between the light emitting area and the light distribution luminosity in a case of a wide-angle light distribution. FIG. 15 is a second drawing showing the relationship between the light emitting area and the light distribution luminosity in a case of a wide-angle light distribution. FIGS. 14 and 15 are top views showing images corresponding to light distributions of light emitted from the light emitting device 1-1 through the TIR lens 21-1 as in FIG. 11 and then through the projection lens 22-1 shown in FIG. 3.

FIG. 14 shows the light distribution D-1 in a case where the light emitting area of the light emitting device 1-1 is wide. This is a case where, for example, the light emitting surface 11-1 shown in FIG. 4 is used in the light emitting device 1-1 shown in FIG. 11. On the other hand, FIG. 15 shows a light distribution D-1′ in a case where the light emitting area of the light emitting device 1-1 shown in FIG. 11 is narrow. This is a case where, for example, the light emitting surface 11-5 shown in FIG. 5 is used in the light emitting device 1-1 shown in FIG. 11. In FIGS. 14 and 15, the higher the luminance of the image and the whiter the image appears, the higher the luminosity of the output light. On the other hand, the lower the luminance of the image and the darker the image appears, the lower the luminosity of the output light.

As shown in FIGS. 14 and 15, in the case of a wide-angle light distribution, the luminosity of the light distribution D-1 is generally higher than the luminosity of the light distribution D-1′, which corresponds to the case of the smaller light emitting area of the light emitting device 1 than that in the case of the light distribution D-1. Thus, in the case of a wide-angle light distribution, the larger the light emitting area of the light emitting device 1, the more possible it is to perform illumination with brighter light having a higher luminosity. When the luminosity of the light distribution D-1 is generally higher, the light distribution angle of the light distribution D-1, which is formed at the luminosity equal to or higher than a predetermined luminosity, is wider than the light distribution angle of the light distribution D-1′, which is formed under the same conditions. Thus, in the present embodiment, in the case of a wide-angle light distribution, it is possible to determine the luminosity of the light distribution, by determining the light emitting area of the light emitting device 1. In the present embodiment, inclusion of the light emitting area of the light emitting device 1 in light distribution control factors allows for increasing the variety of light distributions that can be generated.

### (In Case of Narrow-Angle Light Distribution)

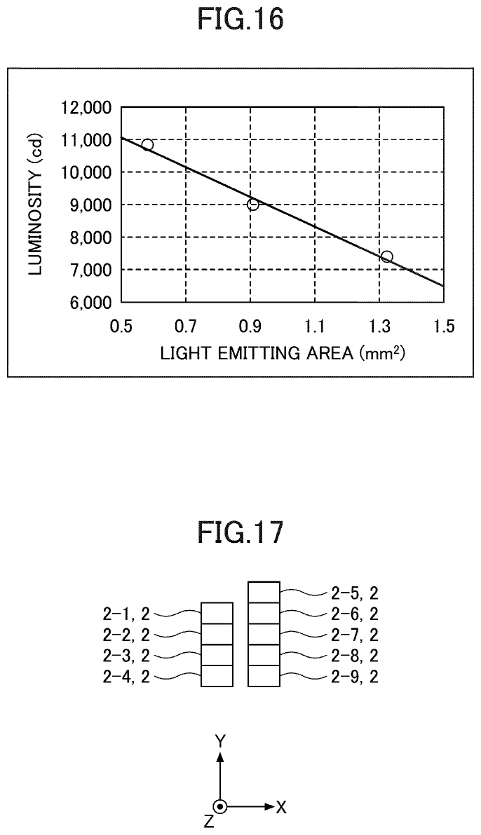

Next, FIG. 16 shows an example of the relationship between the light emitting area of the light emitting device 1 and the light distribution luminosity in a case of a narrow-angle light distribution. In FIG. 16, the horizontal axis indicates the light emitting area of the light emitting device 1, and the vertical axis indicates the light distribution luminosity.

As shown in FIG. 16, in the case of a narrow-angle light distribution, the light distribution luminosity increases as the light emitting area of the light emitting device 1 decreases. Thus, in the case of a narrow-angle light distribution, the smaller the light emitting area of the light emitting device 1, the more possible it is to perform illumination with brighter light having a higher luminosity. As described above, in the present embodiment, in the case of a narrow-angle light distribution, it is possible to determine the luminosity of light distribution by determining the light emitting area of the light emitting device 1. Also, in the present embodiment, the variety of light distributions that can be generated can be increased by including the light emitting area of the light emitting device 1 among light distribution control factors.

### MODIFICATION EXAMPLE

Various modifications are applicable to the arrangement of the light emitting devices and the optical systems in the vehicular lamp according to the embodiment. Modification examples will be described below. FIG. 17 is a schematic diagram showing the arrangement of the light emitting devices 1 and the optical systems 2 according to a modification example. FIG. 17 shows nine optical systems 2 in a top view. In FIG. 17, nine light emitting devices 1 are situated on the −Z side of the nine optical systems 2 in a manner corresponding to and coinciding with the optical systems 2. In the following description of the modification example, for simplification of explanation, mainly the arrangement of the optical systems 2 in a top view will be described, assuming that the light emitting devices 1 and the optical systems 2 are paired.

In FIG. 17, a row of optical systems 2-1 to 2-4 arranged in the Y direction and a row of optical systems 2-5 to 2-9 arranged in the Y direction are arranged in the X direction. The optical systems 2-1 to 2-9 may be arranged in one row in the Y direction. In addition, the optical systems 2-1 to 2-9 may be arranged so as to be in any shape formed by combining one or more straight lines and/or one or more curves. For example, they may be arranged so as to be roughly in an L-letter shape, a U-letter shape, a V-letter shape, an X-letter shape, and the like. Thus, by including the arrangement of the plurality of optical systems 2 in factors of controlling light distribution, the vehicular lamp 100 can emit light that exhibits various light distributions.

In addition, also when the nine optical systems 2 in the above-described embodiment are arranged in the X direction, various arrangement modifications are possible. For example, when the light distribution angles become narrower in order of the optical systems 2-1 to 2-9, they may be arranged as described in (a) to (d) below. Note that a medium angle means a light distribution angle that is between a wide angle and a narrow angle.
(a) The optical systems 2-1 to 2-9 are arranged such that their light distribution angles become wider in this order.
(b) The optical systems 2-1 to 2-9 are arranged such that they have a narrow angle, a wide angle, a medium angle, and a narrow angle in turn.
(c) The optical systems 2-1 to 2-9 are arranged such that they have a medium angle, a narrow angle, and a wide angle in turn.
(d) The optical systems 2-1 to 2-9 are arranged randomly without any particular rule.

### [Second Embodiment]

Next, a vehicle according to a second embodiment will be described. Names and reference numerals that are the same as those in the embodiment and the modification example described above refer to the same or similar members or components, and the detailed description thereof will be omitted where appropriate. This also applies to other embodiments to be described below.

The vehicle according to the second embodiment is mainly different from the first embodiment in that it has the vehicular lamp 100 according to the first embodiment, a sensor configured to acquire information about the external environment, and a control unit configured to select a light emitting device to be caused to emit light from among the plurality of light emitting devices based on the information acquired by the sensor.

### <Configuration Example of Vehicle 500>

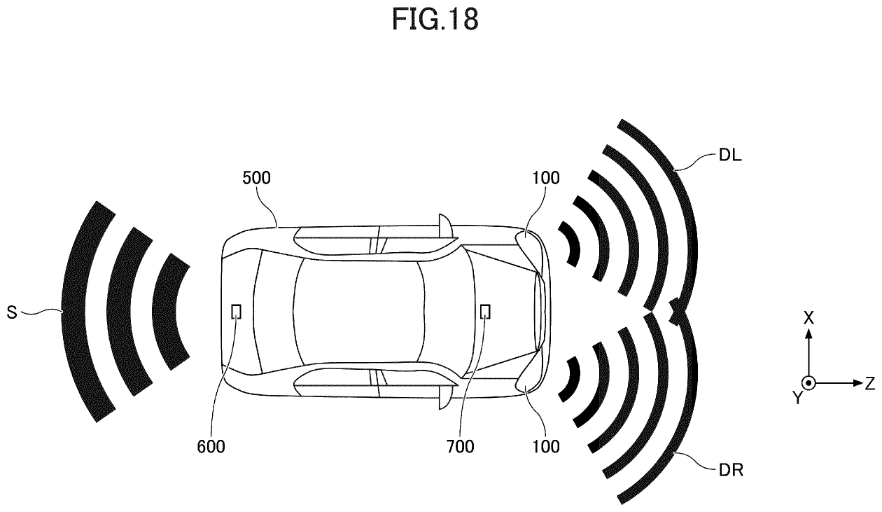

FIG. 18 is a schematic diagram showing an example of a vehicle 500 according to this embodiment. FIG. 18 shows the vehicle 500 viewed from vertically above. As shown in FIG. 18, the vehicle 500 includes the vehicular lamp 100, a sensor 600, and a control unit 700.

The vehicle 500 is equipped with two vehicular lamps 100 in total, with one at the right front part of the vehicle 500 and one at the left front part of the vehicle 500. The vehicular lamp 100 provided at the right front part of the vehicle 500 emits light having a light distribution DR. The vehicular lamp 100 provided at the left front part of the vehicle 500 emits light having a light distribution DL. The same two vehicular lamps 100 may be provided on the vehicle 500 to be in the same orientation, or the same two vehicular lamps 100 may be provided on the vehicle 500 to be in orientations reversed from each other in the X direction. When they are provided in the same orientation, the light distribution DR and the light distribution DL are the same. When they are provided in orientations reversed in the X direction, the light distribution DR and the light distribution DL are reversed relative to each other in the X direction. The vehicular lamps 100 provided on the vehicle 500 may be the ones according to the modification example of the first embodiment. The vehicular lamps 100 provided on the left front part and the right front part of the vehicle 500 are not limited to being the same ones, and, for example, may be ones according to different modification examples. The vehicle 500 may have one vehicular lamp 100 according to the present embodiment on either the right front part or the left front part of the vehicle 500.

The sensor 600 acquires environmental information S, which is information about the external environment. The sensor 600 is, for example, a camera that acquires a captured image of the surroundings of the vehicle 500 as the environmental information S. Alternatively, the sensor 600 may be a Global Positioning System (GPS) sensor or the like that acquires position information of GPS or the like from a Global Navigation Satellite System (GNSS) as the environmental information S. Alternatively, the sensor 600 may be a speedometer that measures the traveling speed of the vehicle 500 and acquires information about the traveling speed as the environmental information S. The traveling speed of the vehicle 500 includes a relative speed with respect to vehicles other than the vehicle 500. The traveling speed of the vehicle 500 falls within the environmental information S from the viewpoint that it is a relative speed with respect to roads outside the vehicle 500 and vehicles other than the vehicle 500. The sensor 600 may acquire information other than the above as the environmental information S. The sensor 600 outputs the acquired information to the control unit 700.

### <Configuration Example of Control Unit 700>

### (Hardware Configuration)

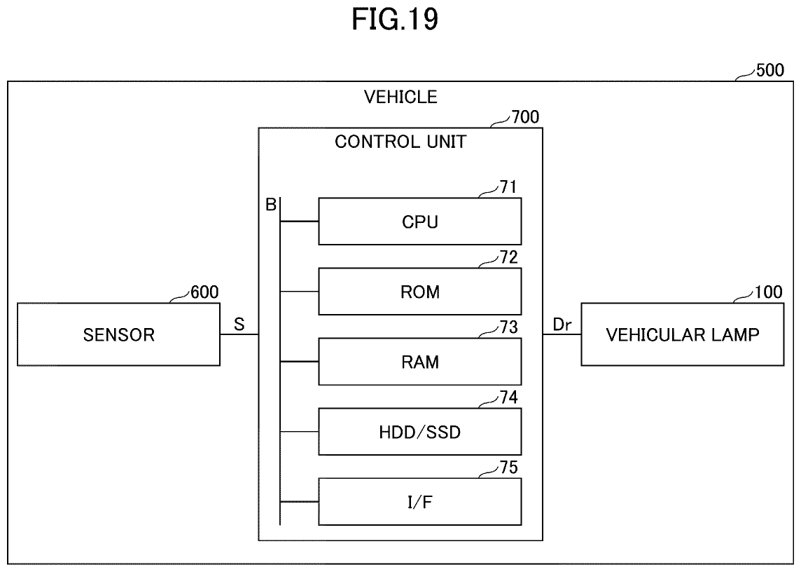

FIG. 19 is a block diagram showing an example of the hardware configuration of the control unit 700. The control unit 700 is composed of a computer. For example, the control unit 700 is an Electronic Control Unit (ECU) mounted on the vehicle 500. However, the control unit 700 is not limited to an ECU, and may be any other computer. The control unit 700 may also be an external computer, an external server, or the like that is communicably connected to the vehicle 500 via wireless communication or the like. The vehicular lamp 100 may also include the control unit 700.

As shown in FIG. 19, the control unit 700 includes a Central Processing Unit (CPU) 71, a Read Only Memory (ROM) 72, and Random Access Memory (RAM) 73. The control unit 700 also includes a Hard Disk Drive/Solid State Drive (HDD/SSD) 74 and an interface (I/F) 75. These are communicably connected to each other through a system bus B. The control unit 700 may also include other components.

The CPU 71 is a processor that executes control processes including various arithmetic processes. The ROM 72 is a nonvolatile memory that stores programs, such as an Initial Program Loader (IPL) or the like, used to drive the CPU 71. The RAM 73 is a volatile memory used as a work area of the CPU 71. The HDD/SSD 74 is a nonvolatile memory that stores various information, such as programs and the like, the environmental information S acquired by the sensor 600, various tables related to the environmental information S, and the like.

The I/F 75 is an interface for connecting the control unit 700 to various external devices. The external devices in the example herein are the vehicular lamps 100, the sensor 600, and the like. For example, the I/F 75 can output a drive signal Dr to the vehicular lamps 100. The I/F 75 may have an interface function for communicating with the external devices through a communication network or the like. For example, the control unit 700 can connect to the Internet via the I/F 75 and communicate with the external devices via the Internet.

### (Functional Configuration)

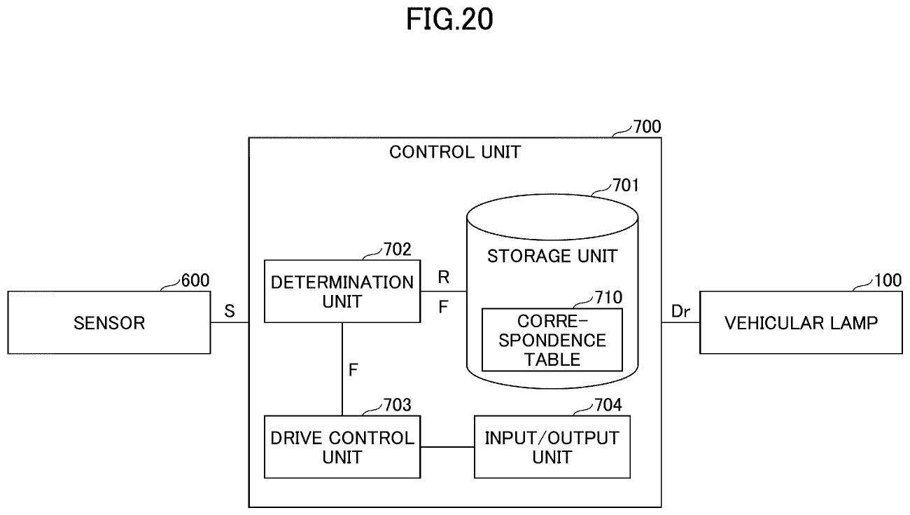

FIG. 20 is a block diagram showing an example of the functional configuration of the control unit 700. As shown in FIG. 20, the control unit 700 includes a storage unit 701, a determination unit 702, a drive control unit 703, and an input/output unit 704. Note that the control unit 700 may have functions other than these.

The functions of the storage unit 701 are realized by a nonvolatile memory, such as the HDD/SSD 74 or the like. The functions of the determination unit 702 and the drive control unit 703 are realized by a processor, such as the CPU 71 shown in FIG. 19 or the like, executing a process defined by a program stored in a non-volatile memory, such as the ROM 72 or the like. The functions of the input/output unit 704 are realized by the I/F 75 or the like. A part of the above functions may be realized by an external device, such as a Personal Computer (PC), a server, or the like, or may be realized by distributed processing between the control unit 700 and an external device. A part of the above functions may be realized by one or a plurality of processing circuits. The processing circuits include an Application Specific Integrated Circuit (ASIC), a Digital Signal Processor (DSP), a Field Programmable Gate Array (FPGA), and the like designed to execute the above functions.

In this embodiment, the control unit 700 causes the vehicular lamp 100 to emit a preferred light distribution in accordance with travel information R when at least some of the plurality of pairs of the plurality of light emitting devices 1 and the plurality of optical systems 2 shown in FIG. 3 emit different light distributions. The travel information R is information that can be acquired from the information S about the external environment acquired by the sensor 600. The travel information R is information indicating, for example, the current situation in which the vehicle 500 is traveling. This situation includes an urban area traveling situation, a suburban area traveling situation, an expressway traveling situation, a situation in which the vehicle is traveling in bad weather, and the like.

For example, in a situation where the vehicle 500 is traveling in an urban area, because many objects, such as oncoming vehicles, pedestrians, motorcycles, guardrails, and the like, may exist in the vicinity of the surroundings of the vehicle 500, it is preferable to illuminate the vicinity in front of the vehicle 500 with a wide-angle light distribution. On the other hand, in a situation in which the vehicle 500 is traveling on an expressway, there may be a preceding vehicle, other than the vehicle 500, that is traveling in front of the vehicle 500 in the same lane. While the vehicle 500 is traveling at a high speed, it is preferable to illuminate a distance in front of the vehicle 500 with a narrow-angle light distribution in order to find any preceding vehicle earlier. In the control unit 700, the determination unit 702 determines the light emitting device 1 that is to be caused to emit light from among the plurality of light emitting devices 1 included in the vehicular lamp 100 shown in FIG. 3, in order to cause the vehicular lamp 100 to emit light having a preferred light distribution in accordance with the travel information R. In the control unit 700, the drive control unit 703 causes the light emitting device 1 determined by the determination unit 702 to emit light. Thus, in this embodiment, information for obtaining the light distribution that is in accordance with the external environment can be provided to the vehicular lamp 100. Moreover, in this embodiment, by causing the vehicular lamp 100 to emit light having a light distribution that is in accordance with the external environment, £ it is possible to perform illumination using light having a suitable light distribution that is in accordance with the external environment.

Among the components shown in FIG. 20, the storage unit 701 stores a correspondence table 710 indicating a correspondence relationship between the travel information R and determination information F, that has been defined by experiments, simulations, or the like. The determination information F is information for determining the light emitting device 1 that is to be caused to emit light among the plurality of light emitting devices 1. The correspondence table 710 is used for the determination unit 702 to determine the light emitting device 1 caused to emit light among the plurality of light emitting devices 1.

The determination unit 702 determines the light emitting device 1 that is to be caused to emit light among the plurality of light emitting devices 1 based on the information acquired by the sensor 600. For example, the determination unit 702 acquires the environmental information S acquired by the sensor 600 via the input/output unit 704. The determination unit 702 acquires the determination information F by referring to the correspondence table 710 stored in the storage unit 701 based on the environmental information S. The determination unit 702 can determine the light emitting device 1 that is to be caused to emit light among the plurality of light emitting devices 1 by acquiring the determination information F. The determination unit 702 outputs the determination information F to the drive control unit 703. The method by which the determination unit 702 determines the light emitting device 1 caused to emit light is not limited to use of the correspondence table 710. For example, the determination unit 702 may estimate the appropriate light distribution by using g a deep neural network or the like based on the environmental information S, and determine the light emitting device 1 that is to be caused to emit light, its luminosity, and the like in accordance with the estimation result.

The drive control unit 703 controls the light emitting operation of the light emitting device 1 determined by the determination unit 702. For example, the drive control unit 703 can control the light emission of the light emitting device 1 corresponding to the determination information F that is input from the determination unit 702, by outputting a drive signal Dr via the input/output unit 704.

### <Example of Correspondence Table 710>

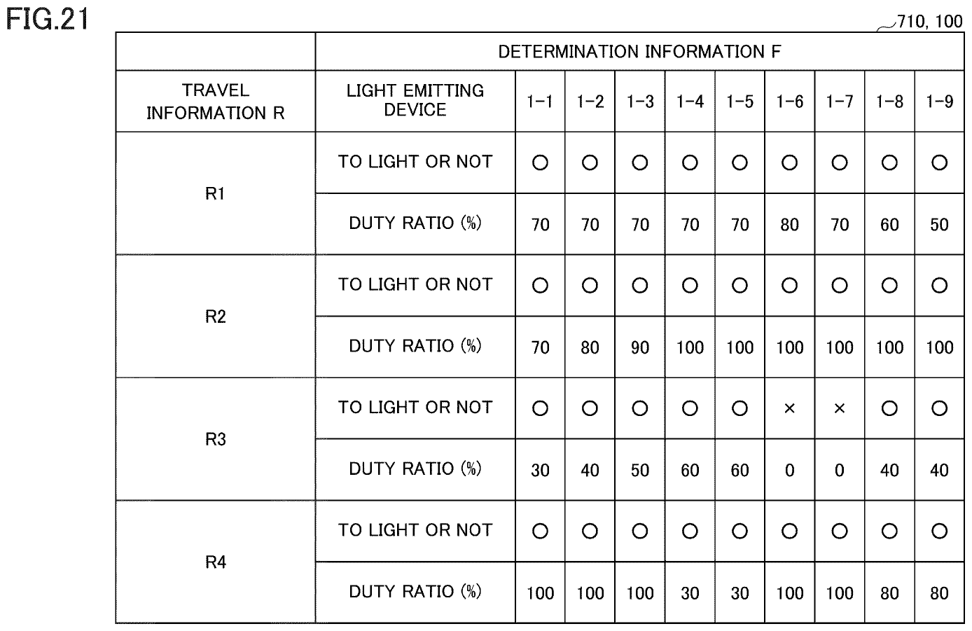

FIG. 21 shows an example of the correspondence table 710 stored in the storage unit 701 shown in FIG. 20. In FIG. 21, the first column shows the travel information R, and the second column shows the determination information F. The determination information F includes, regarding each of the light emitting devices 1-1 to 1-9, whether or not the light emitting device is turned on, and a duty ratio. The travel information R and the determination information F are associated with each other.

Travel information R1 represents an urban area traveling situation. Travel information R2 represents a suburban area traveling situation. Travel information R3 represents an expressway traveling situation. Travel information R4 represents a situation in which the vehicle is traveling in bad weather. The determination information F indicates the light emitting devices to be lit among the plurality of light emitting devices 1-1 to 1-9 shown in FIG. 3, and the duty ratios of the driving times of the light emitting devices to be lit. As shown in the correspondence table 710, the vehicular lamp can be controlled in accordance with the determination information F associated with the travel information R.

The information stored in the correspondence table 710 is not limited to that shown in FIG. 21. For example, the travel information R may include a traveling situation of any vehicle other than the vehicle 500, a traveling situation of any pedestrian, any motorcycle, and the like. The travel information R may include inter-vehicle distance information on the distance between the vehicle 500 and any other vehicle traveling in front of the vehicle 500 on an expressway, and the like. The determination information F may include information specifying the luminosity of the light emitting devices 1 caused to emit light.

<Example of Light Distribution of Light Emitted from Vehicle 500 According to Second Embodiment>

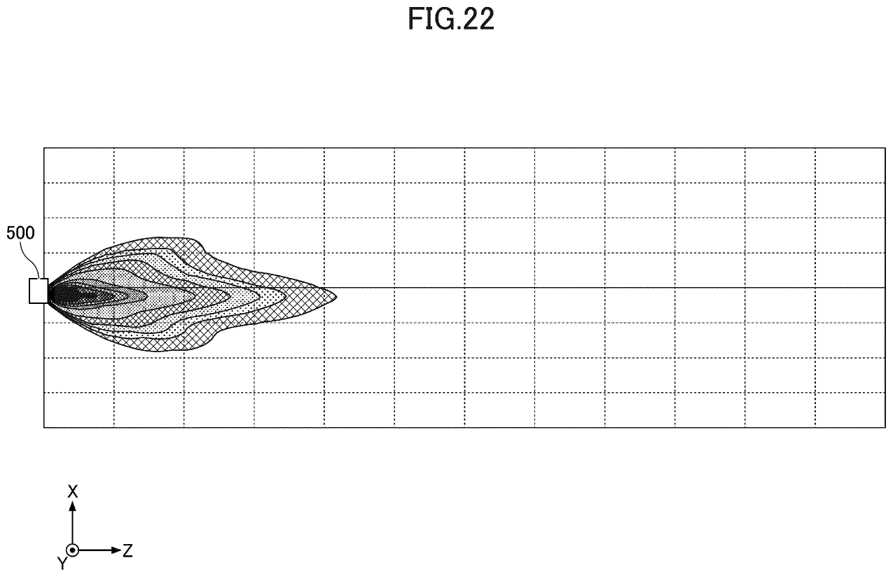

The light distribution of light emitted from the vehicle 500 will be described with reference to FIGS. 22 to 29.

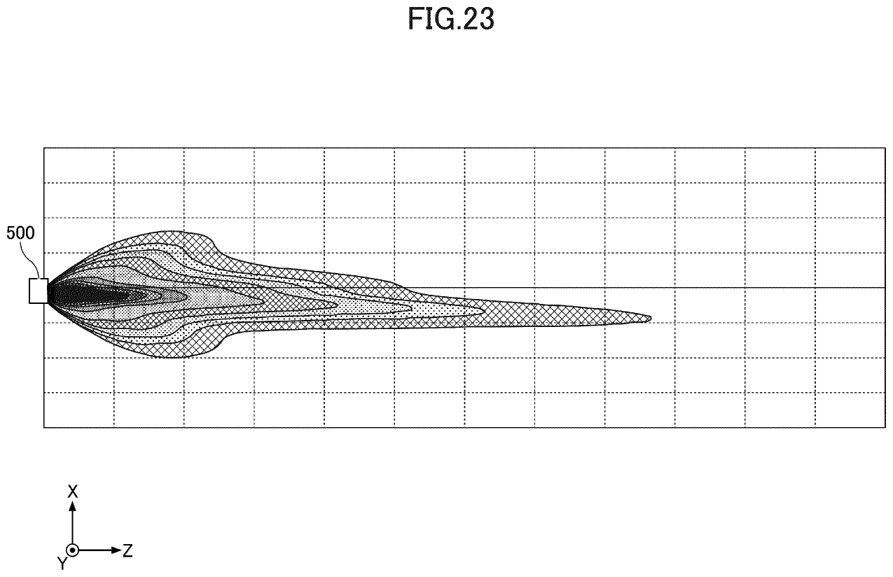

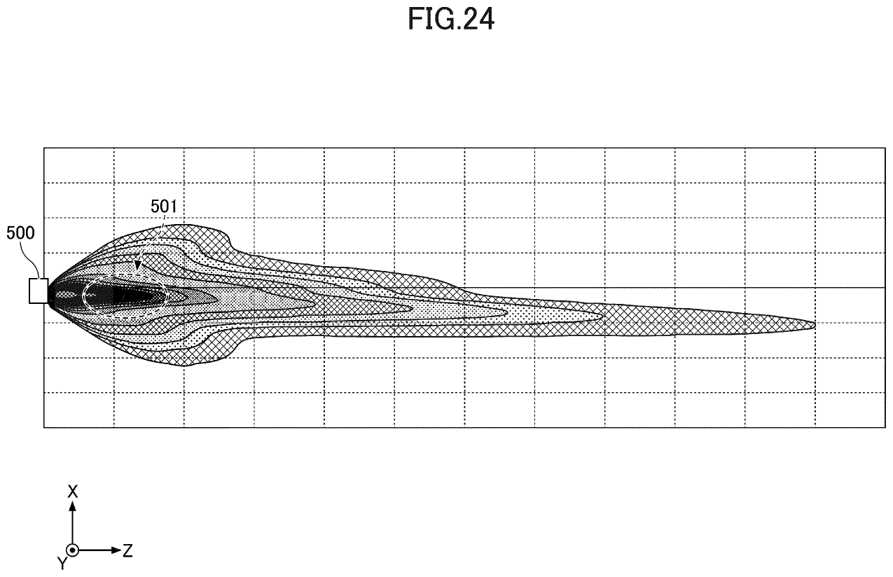

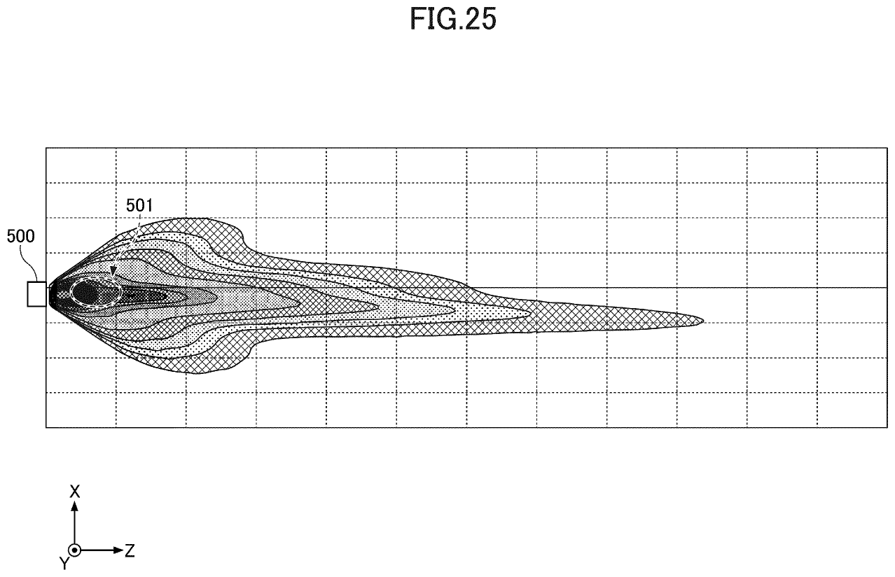

FIGS. 22 to 25 are diagrams showing an example of road surface illuminance by light emitted from the vehicle 500. FIGS. 22 to 25 show the illuminance distribution of the light emitted from the vehicle 500 on a road surface, and show contour plots of the illuminance distribution as seen from above (+Y side) the traveling vehicle 500. In FIGS. 22 to 25, the vehicle 500 is positioned on the leftmost side (−Z side) in each drawing, and emits light forward (to the +Z side) to illuminate its front direction. In FIGS. 22 to 25, regions having the same illuminance are indicated by hatching of the same type. FIG. 22 shows a case of traveling in an urban area, FIG. 23 shows a case of traveling in a suburban area, FIG. 24 shows a case of traveling on an expressway, and FIG. 25 shows a case of traveling in bad weather.

As shown in FIG. 22, because illumination is performed with light having a wide-angle light distribution in an urban area, the light emitted from the vehicle 500 does not reach far and illuminates the vicinity in front of the vehicle 500. As shown in FIG. 23, in a suburban area, the light emitted reaches a position that is farther in front of the vehicle 500 than in the urban area shown in FIG. 22. As shown in FIG. 24, on an expressway, the light emitted reaches a position farther in front of the vehicle 500 than in the suburban area shown in FIG. 23. As shown in FIG. 25, when the vehicle is traveling in bad weather, a hot spot region 501, which indicates a region having a high illuminance, extends only up to a shorter distance in front of the vehicle 500 than a hot spot region 501 on the expressway shown in FIG. 24 or the like. Thus, it is possible to reduce the possibility that the light emitted from the vehicle 500 is reflected by any puddle or the like formed on the road surface. The hot spot region 501 refers to a region having the highest luminosity in a light distribution.

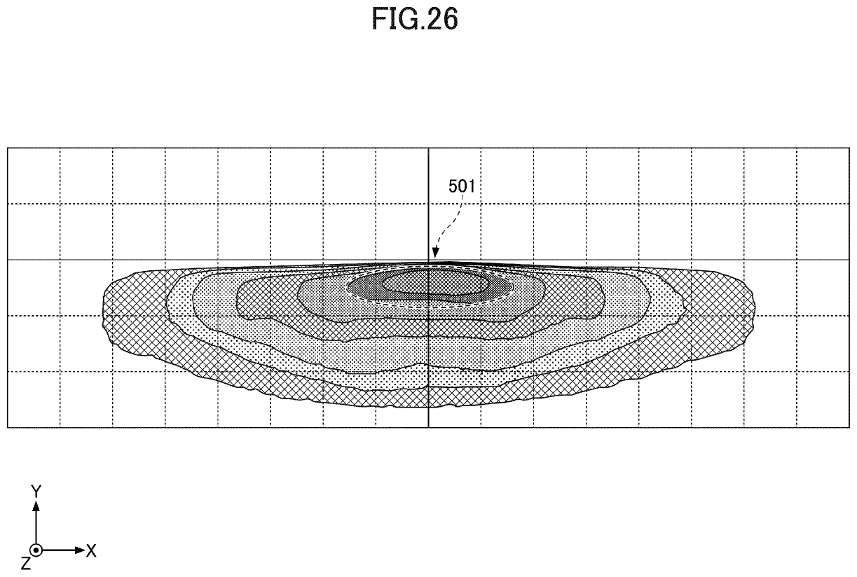

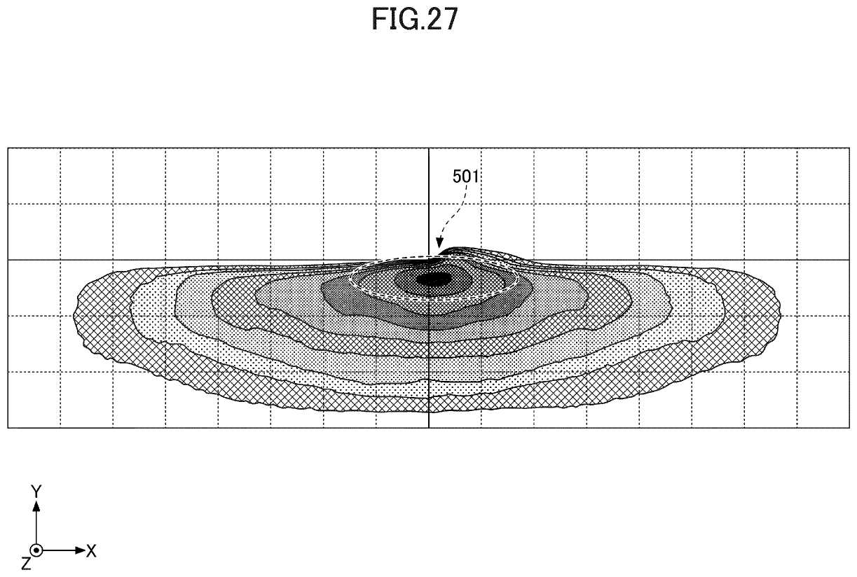

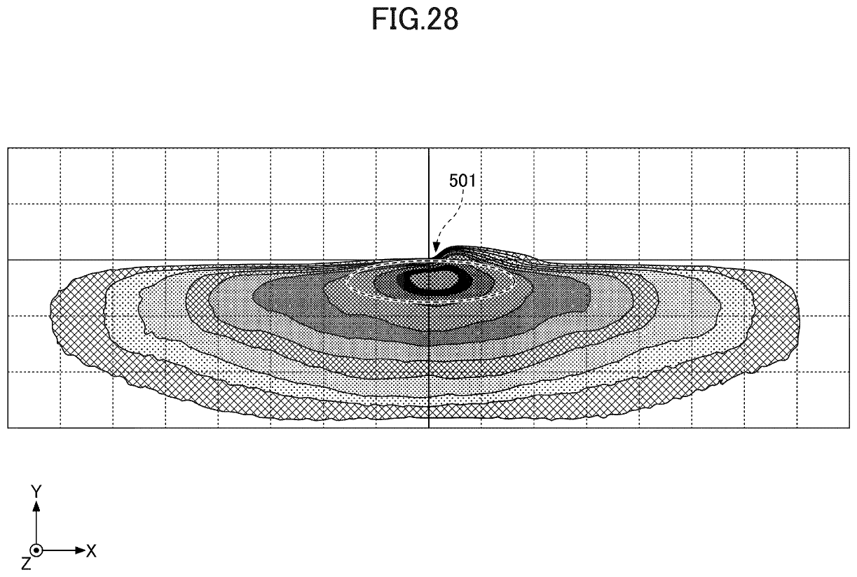

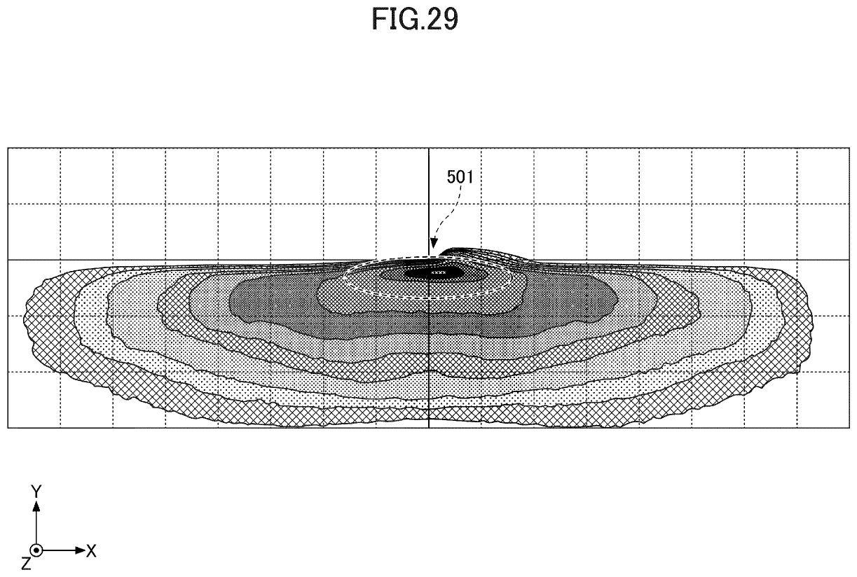

FIGS. 26 to 29 show an example of light distributions by the light emitted from the vehicle 500. FIGS. 26 to 29 are contour plots of the light distributions of light emitted from the vehicle as viewed in the vehicle traveling direction (from the +Z side). In FIGS. 26 to 29, regions having the same luminosity are indicated by hatching of the same type. FIG. 26 shows a case of traveling in an urban area, FIG. 27 shows a case of traveling in a suburban area, FIG. 28 shows a case of traveling on an expressway, and FIG. 29 shows a case of traveling in bad weather.

The light distribution angle is narrower in order of FIGS. 26, 27, and 28, and the narrower the light distribution angle, the higher the luminosity in the hot spot region 501 indicated by the dashed line in the center of the light distribution. Thus, emitted light can reach a far distance in front of the vehicle. In FIG. 29, the length of the hot spot region 501 in the Y direction is shorter than that in FIGS. 26 to 28. Thus, it is possible to reduce the possibility that the light emitted from the vehicle is reflected by any puddle or the like formed on the road surface.

Although the preferred embodiments have been described in detail above, the above-described embodiments are non-limiting, and various modifications and substitutions are applicable to the above-described embodiments without departing from the scope of claims.

The light emitting device of the present disclosure also includes the following modification examples.

### Modification Example 1

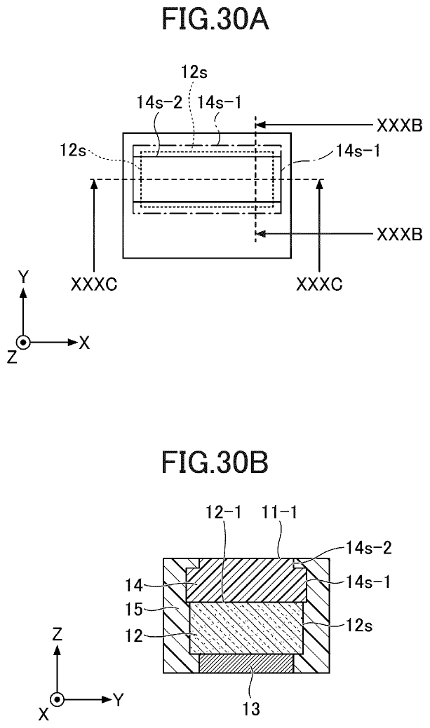

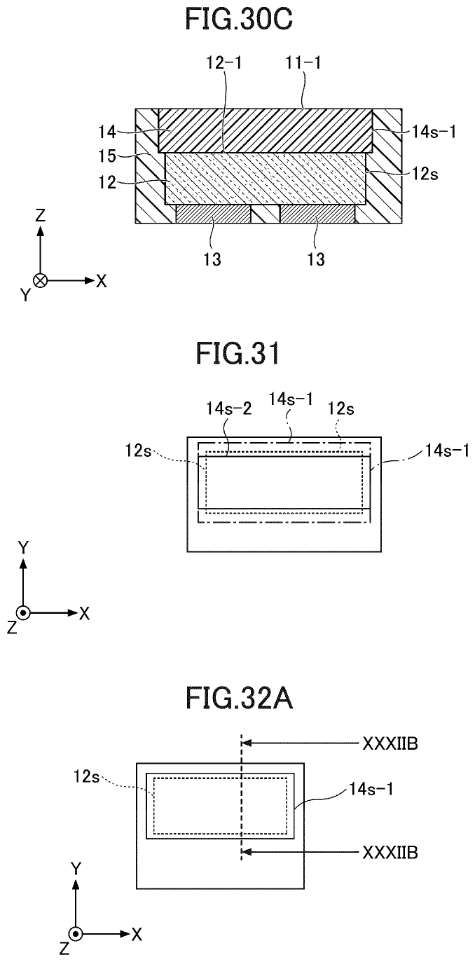

The light emitting device 1 may have the configuration described below. FIG. 30A is a schematic view showing a modification example of the light emitting device 1. The light emitting surface 11-1 of the light emitting device 1 is rectangular in a top view, and the aspect ratio may be, for example, from 1:1.5 or greater and 1:3.5 or less, and preferably from 1:2.5 or greater and 1:3 or less. This makes it easier to obtain a desired light distribution. Specifically, this tends to make the light distribution narrow in the Y direction and wide in the X direction when the vehicular lamp 100 equipped with the light emitting device 1 of the modification example 1 is lit, thereby making it possible to obtain a desired light distribution. The dashed line in FIG. 30A represents outermost lateral surfaces 14s-1 of the wavelength conversion member 14. The dotted line in FIG. 30A represents lateral surfaces 12s of the light emitting surface of the light emitting element 12.

FIG. 30B is a cross-sectional view of the light emitting device 1 along the line XXXB-XXXB. That is, it is a cross-sectional view of the light emitting surface 11-1 of the wavelength conversion member 14 taken in the top-view shorter direction. £ As shown in FIG. 30B, the wavelength conversion member 14 has an upward projecting shape. Thus, the luminance of the light emitting surface 11-1 of the light emitting device 1 is increased. The light shielding member 15 is situated so as to cover the lateral surfaces of the light emitting element 12, the outermost lateral surfaces 14s-1 of the wavelength conversion member 14, and lateral surfaces 14s-2 of the projecting part. Therefore, the size of the light emitting surface 11-1 of the light emitting device 1 corresponds to the size of the projecting part of the wavelength conversion member 14 (that is, the size of the light emitting surface 11-1 of the wavelength conversion member). The Y-direction width of the light emitting element 12 is smaller than the Y-direction width of the outermost part of the wavelength conversion member 14 and larger than the Y-direction width of the projecting part of the wavelength conversion member 14. Thus, the light emitted from the light emitting element 12 and the light wavelength-converted by the wavelength conversion member 14 have reduced color unevenness in the light emitting surface 11-1 of the light emitting device 1.

FIG. 30C is a cross-sectional view of the light emitting device 1 along the XXXC-XXXC line. As shown in FIG. 30C, the wavelength conversion member 14 has no projecting part in the top-view longer direction. That is, the wavelength conversion member 14 has an upward projecting shape only in the shorter direction of the light emitting surface 11-1.

As can be seen from FIGS. 30B and 30C, the number of light emitting elements 12 included in the light emitting device 1 is one. The shape of a light emitting surface 12-1 of the light emitting element 12 is rectangular in a top view. As a result, there being one light emitting surface, luminance unevenness in the light emitting surface can be reduced in comparison with a case where a rectangular light emitting surface is obtained by mounting a plurality of light emitting elements 12 on the light emitting device 1-1. The aspect ratio of the light emitting surface 12-1 of the light emitting element 12 may be, for example, 1:1.5 or greater and 1:5 or less, or 1:2 or greater and 1:4 or less.

### Modification Example 2

FIG. 31 is a schematic diagram showing a modification example of the light emitting device 1. The aspect ratio of the light emitting surface 11-1 is different from that in the light emitting device 1 of the modification example 1. The aspect ratio of the light emitting surface 11-1 of the light emitting device 1 of the modification example 2 may be, for example, 1:3 or greater and 1:5 or less, or 1:3.5 or greater and 1:4.5 or less. Thus, a desired light distribution can be obtained.

### Modification Example 3

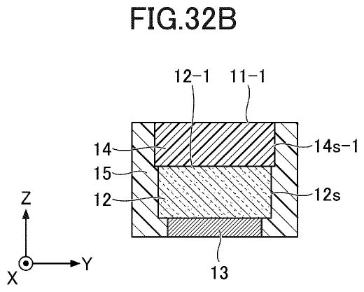

FIG. 32A is a schematic diagram showing a modification example of the light emitting device 1. FIG. 32B is a cross-sectional view of the light emitting device 1 along the line XXXIIB-XXXIIB. As shown in FIG. 32B, the light emitting device 1 of the modification example 3 differs from the light emitting device 1 of the modification example 1 in that it does not have a projecting part in either the Y direction or the X direction. This makes it easier to increase the size of the light emitting surface, leading to increase in the light extraction efficiency. The aspect ratio of the light emitting surface 11-1 of the light emitting device 1 of the modification example 3 is less than or equal to the aspect ratio of the light emitting surface 11-1 of the light emitting device 1 of the modification example 1, and preferably less than the aspect ratio of the light emitting surface 11-1 of the light emitting device 1 of the modification example 1. The aspect ratio of the light emitting surface 11-1 of the light emitting device 1 of the modification example 3 may be, for example, 1:1.5 or greater and 1:3.5 or less, and preferably 1:2 or greater and 1:2.5 or less. This makes it easier for the vehicular lamp 100 equipped with the light emitting device 1 of the modification example 3 to have an increased light extraction efficiency and to also have a narrow light distribution in the Y direction and widened light in the X direction when the vehicular lamp 100 is lit, making it possible to obtain a desired light distribution. The Y-direction width of the light emitting element may be smaller than the Y-direction width of the outermost part of the wavelength conversion member.

The light emitting device described in the modification examples 1 to 3 can be used on the vehicular lamp 100 described in the first embodiment and the vehicle 500 described in the second embodiment. For example, in the vehicular lamp 100, the light emitting devices 1-1 to 1-4 may be the light emitting devices of the modification example 1 to the modification example 3. In this case, the light emitting devices of the modification example 1 to the modification example 3 in which the light emitting surface 11-1 of the wavelength conversion member 14 is rectangular in a top view are the first light emitting device. In this case, the light emitting area of the first light emitting device is larger than the light emitting area of the second light emitting device, and the aspect ratio of the light emitting surface of the first light emitting device is greater than the aspect ratio of the light emitting surface of the second light emitting device. Thus, it is possible to obtain a desired light distribution based on the difference in the light emitting area and the difference in the aspect ratio of the light emitting surface between the first light emitting device and the second light emitting device. That is, this makes it easier to make the light distribution in the Y direction narrow and make the light wide in the X direction when the vehicular lamp 100 is lit, thereby increasing the variety of light distributions. Therefore, a desired light distribution can be easily obtained.

The aspect ratio of the light emitting surface of the first light emitting device is greater than the aspect ratio of the light emitting surface of the second light emitting device, and the ellipticity of the first reflecting part of the first lens (namely, the first reflecting part 213-1 of the TIR lens 21-1) is greater than the ellipticity of the second reflecting part of the third lens (namely, the second reflecting part 213-5 of the TIR lens 21-5). Thus, the light from the first light emitting device can be efficiently spread in the X direction, thereby increasing the variety of light distributions. In a top view, the shape of the light emitting surface 11 of the first light emitting device may be rectangular, and the shape of the light emitting surface 11 of the second light emitting device may be square. This makes it possible to efficiently spread the light distribution in the X direction by means of the first light emitting device, and to efficiently increase the luminosity at the center of the light distribution of a low beam by means of the second light emitting device.

In this specification, a square light emitting surface is not limited to a light emitting surface having an aspect ratio of strictly 1:1, and includes a light emitting surface of which the aspect ratio is deviated from 1:1 due to manufacturing errors. Even a light emitting surface of which the aspect ratio is greater than 1:1 and 1:1.05 or less, and preferably greater than 1:1 and 1:1.01 or less shall be referred to as having a square shape.

All numerical values, such as ordinals, quantities, and the like, used in the description of the embodiments are exemplified for the purpose of specifically explaining the technique of the present disclosure, and the present disclosure is not limited to the exemplified numerical values. The connection relationship between the components is exemplified for the purpose of specifically explaining the technique of the present disclosure, and the connection relationship that realizes the function of the present disclosure is not limited thereto.

The vehicular lamp of the present disclosure is particularly suitable for use as a lighting fixture for automobiles because it is excellent in the variety of light distributions. However, the vehicular lamp of the present disclosure is not limited to vehicle installation. The vehicular lamp of the present disclosure is not limited to use as vehicular lamps, but may also be used as a lighting fixture for an aircraft such as a helicopter, a drone, and the like.

The present disclosure has following Aspects.

### [Aspect 1]

A vehicular lamp, comprising:
a plurality of light emitting devices including a first light emitting device and a second light emitting device and being individually drivable; and
a plurality of optical systems including a first optical system and a second optical system, wherein
the first optical system is configured to output light having a first light distribution based on light incident thereon from the first light emitting device,
the second optical system is configured to output light having a second light distribution based on light incident thereon from the second light emitting device,
a light emitting area of the first light emitting device is different from a light emitting area of the second light emitting device, and
a light distribution angle of the first light distribution is different from a light distribution angle of the second light distribution.

### [Aspect 2]

The vehicular lamp according to Aspect 1,
wherein the light emitting area of the first light emitting device is larger than the light emitting area of the second light emitting device, and
the light distribution angle of the first light distribution is wider than the light distribution angle of the second light distribution.

### [Aspect 3]

The vehicular lamp according to Aspect 1 or 2,
wherein the first optical system includes a first lens and a second lens,
the second optical system includes a third lens and a fourth lens,
the first lens is configured to form a first virtual light source image between the first lens and the second lens based on the light incident from the first light emitting device,
the second lens is configured to output light incident thereon from the first virtual light source image,
the third lens is configured to form a second virtual light source image between the third lens and the fourth lens based on the light incident thereon from the second light emitting device, and
the fourth lens is configured to output light incident thereon from the second virtual light source image.

### [Aspect 4]

The vehicular lamp according to Aspect 3, further comprising:
a shade member located between the first lens and the second lens and located between the third lens and the fourth lens,
wherein the first lens is configured to form the first virtual light source image such that at least a part of the first virtual light source image overlaps the shade member, and
the second lens is configured to form the second virtual light source image such that at least a part of the second virtual light source image overlaps the shade member.

### [Aspect 5]

The vehicular lamp according to Aspect 3 or 4,
wherein the first lens is configured to diverge the light from the first light emitting device and to output the light, and
the third lens is configured to condense the light from the second light emitting device and to output the light.

### [Aspect 6]

The vehicular lamp according to any one of Aspects 3 to 5,
wherein a light axis of the first lens and a light axis of the second lens are positioned on a first straight line,
the first light emitting device is positioned on the first straight line,
a light axis of the third lens and a light axis of the fourth lens are positioned on a second straight line, and
the second light emitting device is positioned on the first straight line.

### [Aspect 7]

The vehicular lamp according to any one of Aspects 3 to 6,
wherein the first lens includes a first reflecting part,
the third lens includes a second reflecting part, and
an area of the first reflecting part is different from an area of the second reflecting part in a top view.

### [Aspect 8]

The vehicular lamp according to Aspect 7,
wherein an outer shape of the first reflecting part in a top view is elliptical, and
an outer shape of the second reflecting part in a top view is circular.

### [Aspect 9]

The vehicular lamp according to any one of Aspects 1 to 8, further comprising:
a third light emitting device being individually drivable; and
a third optical system configured to output light having a third light distribution based on light incident thereon from the third light emitting device,
wherein the light emitting area of the first light emitting device, the light emitting area of the second light emitting device, and a light emitting area of the third light emitting device are different from one another, and
the light distribution angle of the first light distribution, the light distribution angle of the second light distribution, and a light distribution angle of the third light distribution are different from one another.

### [Aspect 10]

The vehicular lamp according to Aspect 9,
wherein the light emitting area of the second light emitting device is larger than the light emitting area of the third light emitting device, and
the light distribution angle of the second light distribution is wider than the light distribution angle of the third light distribution.

### [Aspect 11]

The vehicular lamp according to Aspect 10,
wherein the third optical system includes a fifth lens and a sixth lens,
the fifth lens is configured to form a third virtual light source image between the fifth lens and the sixth lens based on the light incident thereon from the third light emitting device, and
the sixth lens is configured to project light incident thereon from the third virtual light source image.

### [Aspect 12]

The vehicular lamp according to Aspect 11,
wherein a light axis of the fifth lens and a light axis of the sixth lens are positioned on a third straight line, and
the third light emitting device is positioned on the third straight line.

### [Aspect 13]

The vehicular lamp according to any one of Aspects 1 to 12,
wherein the plurality of light emitting devices are arranged in a grid form, and
the plurality of optical systems are arranged in a grid form.

### [Aspect 14]

The vehicular lamp according to any one of Aspects 3 to 8,
wherein, in a top view, an outer shape of a reflecting part of either the second lens or the fourth-lens conforms to an outer shape of the vehicular lamp.

### [Aspect 15]

The vehicular lamp according to any one of Aspects 1 to 14, further comprising:
a control unit configured to determine the light emitting device that is to be caused to emit light from among the plurality of light emitting devices.

### [Aspect 16]

A vehicle, comprising:
the vehicular lamp according to any one of Aspects 1 to 14;
a sensor configured to acquire information about an external environment; and
a control unit configured to determine the light emitting device that is to be caused to emit light from among the plurality of light emitting devices based on the information acquired by the sensor.

### [Aspect 17]

The vehicular lamp according to Aspect 7 or 8,
wherein an ellipticity of the first reflecting part is greater than an ellipticity of the second reflecting part.

### [Aspect 18]

The vehicular lamp according to any one of Aspects 1 to 17,
wherein an aspect ratio of a light emitting surface of the first light emitting device is greater than an aspect ratio of a light emitting surface of the second light emitting device.

### [Aspect 19]

The vehicular lamp according to any one of Aspects 1 to 18,
wherein in a top view, a shape of a light emitting surface of the first light emitting device is rectangular, and a shape of a light emitting surface of the second light emitting device is square.

This application claims priority based on Japanese Patent Application No. 2023-028754, filed with the Japan Patent Office on Feb. 27, 2023, and Japanese Patent Application No. 2023-060390, filed with the Japan Patent Office on Apr. 3, 2023, and the entire contents of the Japanese patent applications are incorporated herein.

### REFERENCE CHARACTERS LIST

1, 1-2 to 1-4, 1-6 to 1-8 light emitting device
1-1 light emitting device (example of first light emitting device)
1-5 light emitting device (example of second light emitting device)
1-9 light emitting device (example of third light emitting device)
11-1, 11-2, 11-3 light emitting surface
12 light emitting element 12
13 electrode
14 wavelength conversion member
15 light shielding member
2, 2-2 to 2-4, 2-6 to 2-8 optical system
2-1 optical system (example of first optical system)
2-5 optical system (example of second optical system)
2-9 optical system (example of third optical system)
21-1 to 21-9 TIR lens
22-1 to 22-9 projection lens
210-1 recessed part
211-1 first light incident part
212-1 second light incident part
213-2 to 213-4, 213-6 to 213-9 reflecting part
213-1 reflecting part (example of first reflecting part)
213-5 reflecting part (example of second reflecting part)
214 light outputting part
3 shade member
31 first shade member
32 second shade member
5 substrate
51 wiring
52 conductive adhesive member
71 CPU
72 ROM
73 RAM
74 HDD/SSD
75 I/F
100 vehicular lamp
200 high-beam lighting fixture
300 support member
500 vehicle
501 hot spot region
600 sensor
700 control unit
701 storage unit
702 determination unit
703 drive control unit
704 input/output unit
710 correspondence table
A1, A2, A3, A4, A5, A6 light axis
B system bus
F determination information
Li-1, Li-5 propagating light
LN1 first straight line
LN2 second straight line
LN3 third straight line
W1, W5 length
D-1 to D-9, D-1′, DL, DR light distribution
Dr drive signal
R travel information
S environmental Information

1. A vehicular lamp, comprising:
a plurality of light emitting devices including a first light emitting device and a second light emitting device and being individually drivable; and
a plurality of optical systems including a first optical system and a second optical system, wherein
the first optical system is configured to output light having a first light distribution based on light incident thereon from the first light emitting device,
the second optical system is configured to output light having a second light distribution based on light incident thereon from the second light emitting device,
a light emitting area of the first light emitting device is different from a light emitting area of the second light emitting device, and
a light distribution angle of the first light distribution is different from a light distribution angle of the second light distribution.

2. The vehicular lamp according to claim 1,
wherein the light emitting area of the first light emitting device is larger than the light emitting area of the second light emitting device, and
the light distribution angle of the first light distribution is wider than the light distribution angle of the second light distribution.

3. The vehicular lamp according to claim 1,
wherein the first optical system includes a first lens and a second lens,
the second optical system includes a third lens and a fourth lens,
the first lens is configured to form a first virtual light source image between the first lens and the second lens based on the light incident from the first light emitting device,
the second lens is configured to output light incident thereon from the first virtual light source image,
the third lens is configured to form a second virtual light source image between the third lens and the fourth lens based on the light incident thereon from the second light emitting device, and
the fourth lens is configured to output light incident thereon from the second virtual light source image.

4. The vehicular lamp according to claim 3, further comprising:
a shade member located between the first lens and the second lens and located between the third lens and the fourth lens,
wherein the first lens is configured to form the first virtual light source image such that at least a part of the first virtual light source image overlaps the shade member, and
the second lens is configured to form the second virtual light source image such that at least a part of the second virtual light source image overlaps the shade member.

5. The vehicular lamp according to claim 3,
wherein the first lens is configured to diverge the light from the first light emitting device and to output the light, and
the third lens is configured to condense the light from the second light emitting device and to output the light.

6. The vehicular lamp according to claim 3,
wherein a light axis of the first lens and a light axis of the second lens are positioned on a first straight line,
the first light emitting device is positioned on the first straight line,
a light axis of the third lens and a light axis of the fourth lens are positioned on a second straight line, and
the second light emitting device is positioned on the second straight line.

7. The vehicular lamp according to claim 3,
wherein the first lens includes a first reflecting part,
the third lens includes a second reflecting part, and
an area of the first reflecting part is different from an area of the second reflecting part in a top view.

8. The vehicular lamp according to claim 7,
wherein an outer shape of the first reflecting part in a top view is elliptical, and
an outer shape of the second reflecting part in a top view is circular.

9. The vehicular lamp according to claim 1, further comprising:
a third light emitting device that is individually drivable; and
a third optical system configured to output light having a third light distribution based on light incident thereon from the third light emitting device,
wherein the light emitting area of the first light emitting device, the light emitting area of the second light emitting device, and a light emitting area of the third light emitting device are different from one another, and
the light distribution angle of the first light distribution, the light distribution angle of the second light distribution, and a light distribution angle of the third light distribution are different from one another.

10. The vehicular lamp according to claim 9,
wherein the light emitting area of the second light emitting device is larger than the light emitting area of the third light emitting device, and
the light distribution angle of the second light distribution is wider than the light distribution angle of the third light distribution.

11. The vehicular lamp according to claim 10,
wherein the third optical system includes a fifth lens and a sixth lens,
the fifth lens is configured to form a third virtual light source image between the fifth lens and the sixth lens based on the light incident thereon from the third light emitting device, and
the sixth lens is configured to project light incident thereon from the third virtual light source image.

12. The vehicular lamp according to claim 11,
wherein a light axis of the fifth lens and a light axis of the sixth lens are positioned on a third straight line, and
the third light emitting device is positioned on the third straight line.

13. The vehicular lamp according to claim 1,
wherein the plurality of light emitting devices are arranged in a grid form, and
the plurality of optical systems are arranged in a grid form.

14. The vehicular lamp according to claim 8,
wherein, in a top view, the outer shape of either the first reflecting part of first lens or the second reflecting part of the third lens conforms to an outer shape of the vehicular lamp.

15. The vehicular lamp according to claim 1, further comprising:
a control unit configured to determine the light emitting device that is to be caused to emit light from among the plurality of light emitting devices.

16. A vehicle, comprising:
the vehicular lamp according to claim 1;
a sensor configured to acquire information about an external environment; and
a control unit configured to determine the light emitting device that is to be caused to emit light from among the plurality of light emitting devices based on the information acquired by the sensor.

17. The vehicular lamp according to claim 7,
wherein an ellipticity of the first reflecting part is greater than an ellipticity of the second reflecting part.

18. The vehicular lamp according to claim 1,
wherein an aspect ratio of a light emitting surface of the first light emitting device is greater than an aspect ratio of a light emitting surface of the second light emitting device.

19. The vehicular lamp according to claim 1,
wherein, in a top view, a shape of a light emitting surface of the first light emitting device is rectangular, and a shape of a light emitting surface of the second light emitting device is square.
